(19) United States
(12) Patent Application Publication
(10) Pub. No.: US 2016/0011889 A1
(43) Pub. Date: Jan. 14, 2016

(54) SIMULATION METHOD AND STORAGE MEDIUM

(71) Applicant: FUJITSU LIMITED, Kawasaki-shi (JP)

(72) Inventors: David Thach, Meguro (JP); Atsushi Ike, Minato (JP)

(73) Assignee: FUJITSU LIMITED, Kawasaki-shi (JP)

(21) Appl. No.: 14/790,173

(22) Filed: Jul. 2, 2015

(30) Foreign Application Priority Data
Jul. 10, 2014 (JP) 2014-142130

(51) Int. Cl. G06F 9/455

(52) U.S. Cl. CPC G06F 9/455

(57) ABSTRACT

A method includes: each time a target block to be simulated among blocks produced by dividing a program of a target processor to be simulated changes from one to another among the blocks, generating and storing in a memory, association information that associates an internal state of the target processor with a performance value of each instruction of the target block, and an execution code of the target processor to which program included in the target block is converted; executing the execution code using the association information associated with the internal state to calculate the performance value of the target block; deleting the execution code and the association information of a block to be deleted from among the plurality of blocks produced by dividing the program of the target processor based on a probability of execution in response to a branch in a preceding block in execution from the memory.

### CROSS-REFERENCE TO RELATED APPLICATION

This application is based upon and claims the benefit of priority of the prior Japanese Patent Application No. 2014-142130, filed on Jul. 10, 2014, the entire contents of which are incorporated herein by reference.

### FIELD

The embodiment disclosed herein is related to a simulation method and a storage medium.

### BACKGROUND

To support development of a program, there is proposed a technique of estimating performances of the program such as a run time by simulating an execution of the program on processors. There is also proposed a technique of dividing a program code into multiple blocks, and calculating the number of static execution cycles of each of the blocks in consideration of pipeline interlocks.

Examples of conventional technical documents on such program simulation include Japanese Laid-open Patent Publications No. 2013-84178 and No. 9-6646.

However, in the out-of-order execution processor, in executing instructions of a program, an instruction of a certain block may not follow a program order of instructions but overtake an instruction of another block. For this reason, the performances of blocks executed by the processor vary depending on execution states. Therefore, in some cases, the performances is not accurately estimated.

In addition, as execution of simulation is continued, free space on a memory may become smaller. In this case, insufficient free space on the memory may decelerate the simulation.

### SUMMARY

According to an aspect of the invention, a simulation method to be executed by a computer including a processor configured to execute processing and a memory configured to store an execution result of the processor, the method includes: each time a target block to be simulated among a plurality of blocks produced by dividing a program of a target processor to be simulated changes from one to another among the plurality of blocks, generating association information that associates an internal state of the target processor with a performance value of each instruction of the target block, and an execution code of the target processor to which program included in the target block is converted; storing the generated association information and execution code in the memory; executing the execution code using the association information associated with the internal state to calculate the performance value of the target block; selecting a block to be deleted from among the plurality of blocks produced by dividing the program of the target processor based on a probability of execution in response to a branch in a preceding block in execution; and deleting the execution code and the association information of the selected block from the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of hardware structure of a simulation apparatus in accordance with an embodiment;

FIG. 2 is a view illustrating an example of a target CPU;

FIG. 3 is a view illustrating an example of the operation of the simulation apparatus (FIG. 1) in accordance with this embodiment;

FIG. 4 is a view illustrating block information generated by the simulation apparatus in the case of the out-of-order execution target CPU;

FIG. 5 is a view illustrating software module structure of the simulation apparatus in accordance with this embodiment;

FIG. 6 illustrates an example of instructions of a block;

FIG. 7 illustrates an example of timing information of each instruction included in the block in FIG. 6;

FIGS. 8A and 8B illustrate an example of execution timing of each instruction in the block in FIG. 6;

FIG. 9 illustrates an example of blocks of a target program;

FIG. 10 illustrates an example of an execution code;

FIG. 11 illustrates an example of a performance value table;

FIG. 12 is a first flow chart illustrating an example of a procedure of simulation processing of the simulation apparatus in the embodiment;

FIG. 13 is a second flow chart illustrating an example of a procedure of simulation processing of the simulation apparatus in the embodiment;

FIG. 14 is a third flow chart illustrating an example of a procedure of simulation processing of the simulation apparatus in the embodiment;

FIG. 15 illustrates an example of a counter table generated based on a saturating counter;

FIG. 16 is a view illustrating an example of branch between blocks;

FIG. 17 is a view illustrating an algorithm of the saturating counter;

FIG. 18 is a flow chart illustrating processing of detecting a block to be deleted by referring to the counter table;

FIG. 19 is a flow chart illustrating branch prediction processing executed based on the counter table;

FIG. 20 is a flow chart illustrating processing of the execution code by a code execution unit; and

FIG. 21 is a flow chart illustrating calling processing of a correction unit in FIG. 20 in detail.

### DESCRIPTION OF EMBODIMENT

According to a first aspect of an embodiment of a disclosed simulation method, simulation can be accelerated while improving the estimation accuracy. The embodiment will be described below with reference to figures. However, the technical scope of the disclosure is not limited to the embodiment, and covers matters recited in claims and their equivalents.

[Hardware Structure of Simulation Apparatus]

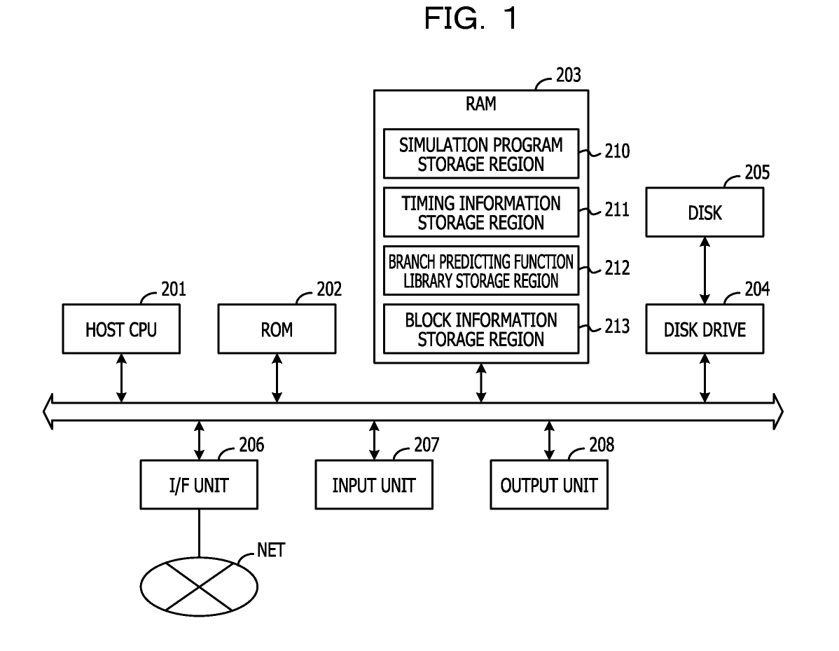

FIG. 1 is a block diagram illustrating an example of hardware structure of a simulation apparatus in accordance with the embodiment. A simulation apparatus 100 includes a host central processing unit (CPU) 201, a read only memory (ROM) 202, a random access memory (RAM) 203, a disk drive 204, and a disk 205. The simulation apparatus 100 further includes an interface (I/F) unit 206, an input unit 207, and an output unit 208. The constituents are interconnected via a bus 200.

The disk drive 204 controls read/write of data from/into the disk 205 under the control of the host CPU 201. The disk 205 stores data written under the control of the disk drive 204. Examples of the disk 205 include a magnetic disk and an optical disk. The I/F unit 206 is connected to network NET such as a local area network (LAN), a wide area network (WAN), and the Internet via a communication line, and is connected to another apparatus via the network NET. The I/F unit 206 interfaces with the network NET, and controls input/output of data from/to an external apparatus. For example, a network interface card (NIC) or a LAN adaptor may be used as the I/F unit 206.

The input unit 207 is an interface for inputting various types of data by the operation of the user with a keyboard, a mouse, a touch panel, and so on. The input unit 207 can take images and animation images from a camera. The input unit 207 can also take voice from a microphone. The output unit 208 is an interface for outputting data according to an instruction provided by the host CPU 201. Examples of the output unit 208 include a display and a printer.

The host CPU 201 manages the entire simulation apparatus 100. The ROM 202 stores programs including a boot program. The RAM 203 is a storage unit used as a work area for the host CPU 201. The RAM 203 has a simulation program storage region 210, a timing information storage region 211, a branch predicting function library storage region 212, and a block information storage region 213 in the embodiment.

A simulation program (hereinafter referred to as simulation program 210) stored in the simulation program storage region 210 is executed by the host CPU 201 to achieve simulation processing in this embodiment. The simulation processing is performance simulation processing in the case where an out-of-order execution processor other than the host CPU 201 in FIG. 1 executes a program of interest. The program of interest will be hereinafter referred to as target program. Timing information 1400 stored in the timing information storage region 211 will be described later.

A branch predicting function library stored in the branch predicting function library storage region 212 (this library is hereinafter referred to as a branch predicting function library 212) is a model of a branch prediction algorithm of a target processor. The block information storage region 213 is a region in which block information generated from the simulation program 210 is stored. The block information includes a block execution code and association information. Details of the execution code and the association information will be described later. In this embodiment, the block information storage region 213 is a fixed region having designated size. However, the block information storage region 213 is not limited to this, and may be a region of variable size.

In this embodiment, the out-of-order execution processor is referred to as a target central processing unit (CPU). A processor 201 of the simulation apparatus 100 is referred to as a host CPU. In the example in FIG. 1, the target CPU is an ARM architecture CPU (registered trademark) manufactured by the ARM Ltd, and the host CPU 201 of the simulation apparatus 100 is an X86 architecture CPU (registered trademark) manufactured by Intel Corporation.

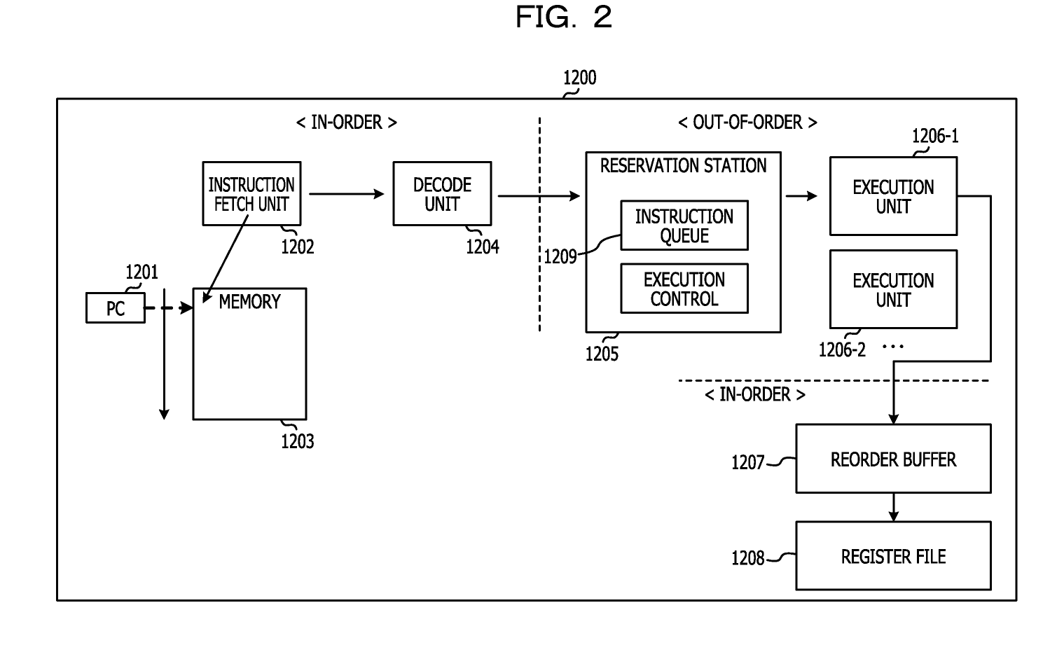

In this embodiment, the simulation apparatus 100 in the case of the out-of-order execution target CPU will be described. First, the out-of-order execution target CPU will be briefly described with reference to FIG. 2.

[Summary of Target Processor]

FIG. 2 is a view illustrating an example of the target CPU. Here, an example of an out-of-order target CPU 1200 will be briefly described. The target CPU 1200 has a program counter (PC) 1201, an instruction fetch unit 1202, a decode unit 1204, and a reservation station 1205 having an instruction queue 1209. The target CPU 1200 has multiple execution units 1206, a reorder buffer 1207, and a register file 1208.

Processing executed by of the target CPU 1200 will be sequentially described.

(1) The target CPU 1200 fetches an instruction from a memory 1203, and decodes the fetched instruction.

(2) The target CPU 1200 enters the decoded instruction in the instruction queue 1209, and records the instruction in the reorder buffer 1207.

(3) The target CPU 1200 puts an instruction that can be executed among instructions in the instruction queue 1209 into the execution unit 1206.

(4) The target CPU 1200 causes the execution unit 1206 to execute the instruction and then, stores an execution result in the reorder buffer 1207.

(5) The target CPU 1200 changes the state of the instruction executed by the execution unit 1206 in the reorder buffer 1207, to completion.

(6) When the earliest instruction among the instructions in the reorder buffer 1207, the target CPU 1200 rewrites the instruction execution result in the register file 1208.

(7) The target CPU 1200 deletes the completed instruction from the reorder buffer 1207.

In this embodiment, the states of the instruction queue 1209, the execution units 1206, and the reorder buffer 1207, and an address of the instruction executed immediately before a target block are used as the internal state of the target CPU 1200.

An example in which the execution order in the program varies in the out-of-order execution target CPU 1200 will now be described. For example, the execution order in the program is assumed as follows. In a below-mentioned instruction example, numbers in ( ) represent the execution order, and descriptions following “;” are notes.

(1) Instruction 1: Idr r0, [r1]; r0<-[r1]

(2) Instruction 2: add r0, r0, 1lr0<-r0+1

(3) Instruction 3: mov r2, 0; r2<-0

Instruction 1 takes long time for execution, and Instruction 2 depends on an execution result of Instruction 1. Thus, the execution order in the program is different from the execution order executed by the out-of-order execution target CPU 1200. For example, the execution order of the instructions executed by the target CPU 1200 is as follows under control of the reservation station 1205. In a below-mentioned instruction example, numbers in ( ) represent the execution order, and descriptions following “;” are notes.

(1) Instruction 1: Idr r0, [r1]; r0<-[r1]

(2) Instruction 3: mov r2, 0; r2<-0

(3) Instruction 2: add r0, r0, 1lr0<-r0+1

Since overtaking of the instruction occurs in the out-of-order execution target CPU 1200, a delay of execution of a certain instruction may affect another block. Blocks are produced by dividing the program code. The execution order of the blocks included in the program is assumed as follows. B1 to B3 are blocks.

B1: Instruction 1 (instruction that takes long time for execution)

B2: Instruction 2 (instruction that depends on Instruction 1)

B2: Instruction 3 (instruction that depends on Instruction 1)

B3: Instruction 4 (instruction that does not depend on Instruction 1)

Instruction 4 is an instruction that does not depend on Instruction 1 and take long time for execution. Accordingly, under control of the reservation station 1205 in the target CPU 1200, Instruction 4 overtakes Instruction 2 and Instruction 3, and is completed.

B1: Instruction 1 (instruction that takes long time for execution)

B3: Instruction 4 (instruction that does not depend on Instruction 1)

B2: Instruction 2 (instruction that depends on Instruction 1)

B2: Instruction 3 (instruction that depends on Instruction 1)

[Summary of Simulation Using Simulation Apparatus 100]

Next, performance simulation executed by the simulation apparatus 100 (FIG. 1) will be summarized below.

In this embodiment, simulation of functions and performances achieved when a first processor to be assessed (in this example, the target CPU 1200 in FIG. 2) executes the target program is performed using a second processor (in this example, the host CPU 201 in FIG. 1) of the simulation apparatus 100. When the second processor (host CPU 201) performs simulation, the target program of the first processor (target CPU 1200) has to be converted into a code executable by the second processor. For example, conversion into the code executable by the second processor is made according to an interpreter mode or Just-In-Time (JIT) complier mode. The simulation apparatus in this embodiment simulates performances according to the JIT complier mode.

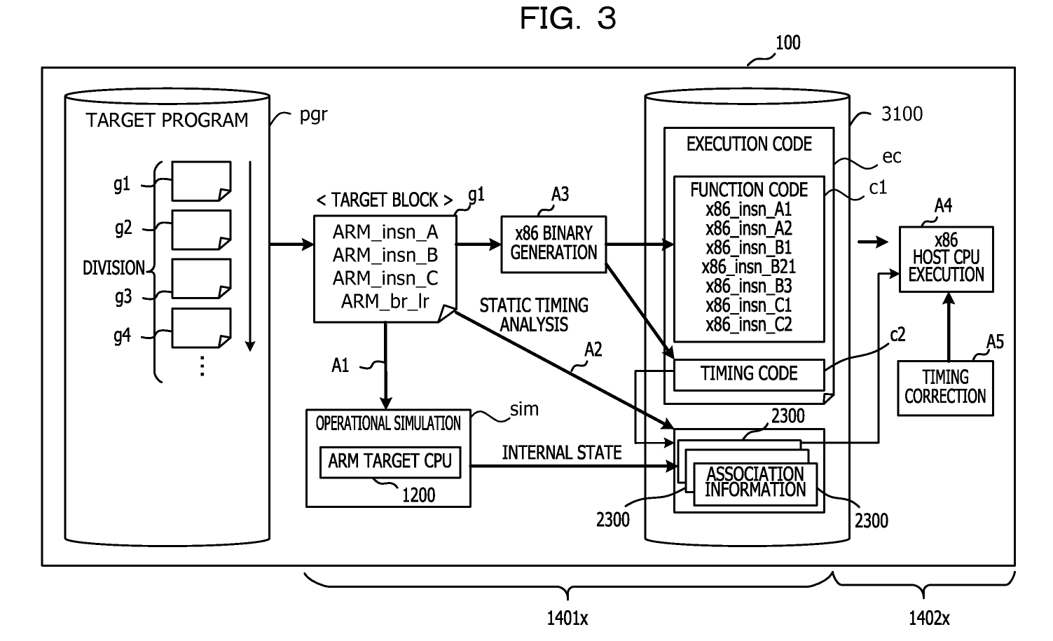

FIG. 3 is a view schematically illustrating an example of the operation of the simulation apparatus 100 (FIG. 1) in this embodiment. FIG. 3 schematically illustrates operational simulation sim performed using the host CPU 201 having X86 architecture when the target CPU 1200 executes a target program pgr.

The operational simulation sim is performed by applying the target program pgr to a model of the target CPU 1200 in FIG. 2 and a model of a hardware resource accessed from the target CPU 1200. A model of a system used herein is, for example, a behavior model that reproduces only system functions by using a hardware description language.

The operational simulation sim in FIG. 3 has code conversion processing 1401x and performance simulation execution processing 1402x. First, in the code conversion processing 1401x, the simulation apparatus 100 divides the code of the target program pgr to generate blocks g1 to g4. The unit of divided blocks may be a basic (base) block unit such as a code from branch to next branch, or any predetermined code unit. The basic block unit is a group of codes included from a branch instruction to a next branch instruction.

All of the blocks may be previously generated, or only the target block may be generated when the block becomes the target block. The one generated block g1 has, for example, instructions “ARM_insn_A”, “ARM_insn_B”, “ARM_insn_C”, “ARM_br_lr”.

When the target block among the blocks g1 to g4 for the operational simulation sim, the simulation apparatus 100 detects an internal state 1600 of the target CPU 1200 in the operational simulation sim (A1). Examples of the internal state 1600 of the target CPU include a set value of a register of the target CPU 1200 in FIG. 2. The simulation apparatus 100 can determine the execution state of the target program pgr based on the set value of the target CPU 1200 in the operational simulation sim.

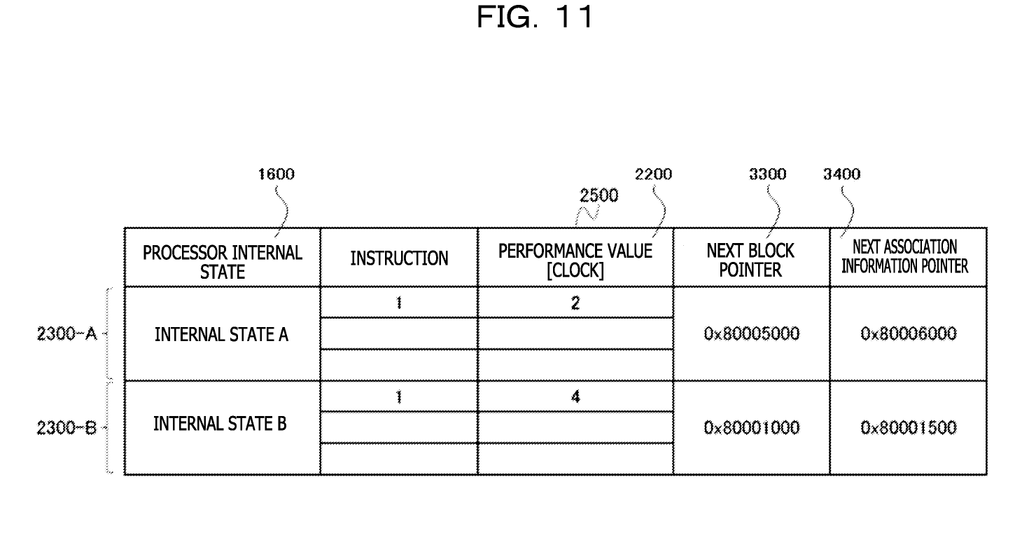

When the target block changes, the simulation apparatus 100 performs static timing analysis according to the detected internal state 1600 and a performance value as a reference of each instruction included in the target block g1 (A2). Thereby, the simulation apparatus 100 calculates the performance value of each instruction included in the target block g1. The simulation apparatus 100 generates association information 2300 that associates the detected internal state 1600 with the performance value of each instruction included in the target block g1. Examples of the performance value include processing time, the number of clocks, and power consumption. FIG. 11 illustrates a specific example of the association information 2300.

When the target block changes, the simulation apparatus 100 receives an input of a programp1 of the target block, and generates an execution code ec executed by the host CPU 201 having the X86 architecture (A3). According to the execution code ec, the host CPU 201 can calculate the performance value acquired when the target block is executed by the target CPU 1200 based on the association information 2300 that associates the internal state 1600 with the performance value.

Specifically, the execution code ec includes a function code c1 and a timing code c2. The function code c1 is a code that can be acquired by compiling the target block g1 and be executed by the host CPU 201. Here, the function code c1 of the target block g1 has instructions “x86_insn_A1”, “x86_insn_A2”, “x86_insn_B1”, “x86_insn_B21”, “x86_insn_B3”, “x86_insn_C1”, and “x86_insn_C2”.

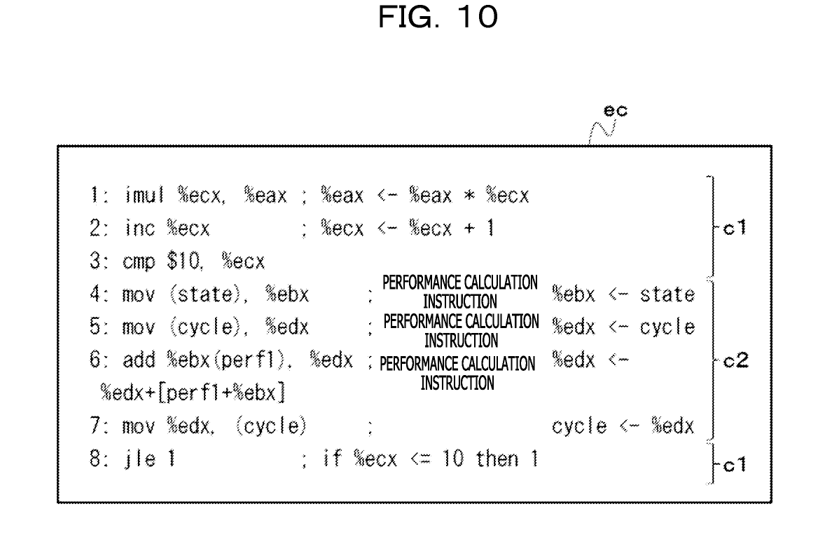

The timing code c2 is a code for estimating the performance value of the function code c1. For example, when the performance value is the number of cycles, the timing code c2 obtains the performance value by using the internal state 1600 as an argument, and adds the number of cycles cycle to the performance value. FIG. 10 illustrates a specific example of cycle=cycle+performance value [internal state] execution code ec. The combination of the execution code ec and the association information 2300 is referred to as block information 3100.

Next, the performance simulation execution processing 1402x will be described. In the performance simulation execution processing 1402x, the simulation apparatus 100 executes the execution code ec converted according to the X86 architecture (A4). Specifically, the simulation apparatus 100 executes the execution code ec by using the generated association information 2300 and the detected internal state 1600 on the target block g1, to calculate the performance value achieved when the target CPU executes the target block g1. The simulation apparatus 100 corrects the performance value according to the execution result of an external dependence instruction in the target block g1 (A5).

As described above with reference to FIG. 2, in the out-of-order execution target CPU 1200, the execution order in the program is different from the execution order of the target CPU 1200. In the out-of-order execution target CPU 1200, instruction overtaking occurs.

Accordingly, the simulation apparatus 100 in this embodiment detects the internal state 1600 of the target CPU 1200 when the target block changes, and statically calculate the performance value of the each instruction of the target block in the detected internal state 1600. Then, the simulation apparatus 100 executes the execution code ec based on the association information 2300, and calculates the performance value corresponding to the internal state 1600. In this manner, the accuracy of estimating the performance value when the out-of-order execution target CPU 1200 executes the target block can be improved.

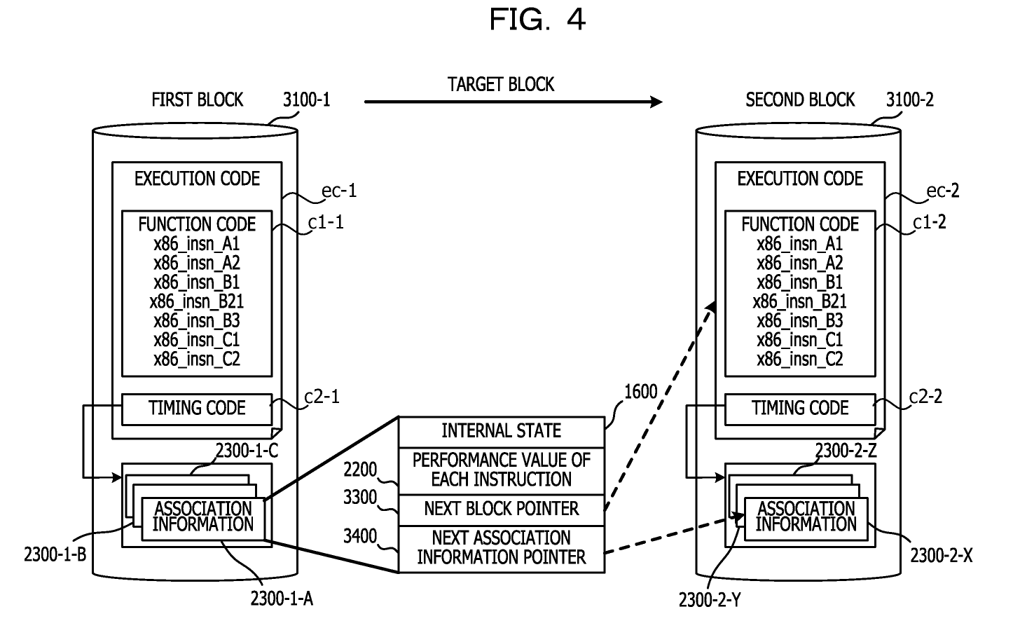

FIG. 4 is a view illustrating the block information 3100 generated by the simulation apparatus 100 in the case of the out-of-order execution target CPU. As described above with reference to FIG. 3, in the case of the out-of-order execution target CPU, the simulation apparatus 100 generates the block information 3100 including the execution code ec and the association information 2300. As described above with reference to FIG. 1, the block information 3100 is stored in, for example, the block information storage region 213 of the RAM 203.

In the example in FIG. 4, “-number” assigned to each of the block information 3100, the execution code ec, function code c1, the timing code c2, and the association information 2300 represents which block the association information is related. “-alphabet” assigned to each association information 2300 serves to identify the internal state 1600.

FIG. 4 illustrates the case where the simulation apparatus 100 simulates performances of a first block 3100-1, and in turn, a second block 3100-2. As described above with reference to FIG. 3, the simulation apparatus 100 generates the execution codes ec and the association information 2300 of the first block 3100-1 and the second block 3100-2. As described above with reference to FIG. 3, the execution code ec includes the function code c1 and the timing code c2.

The execution code ec generated in this embodiment is not a code that describes a specific performance value, but a code that can acquire the performance value. Thus, the execution code ec does not have to be generated multiple times for the same block. Accordingly, when it is determined that a block has not been the target block, the simulation apparatus 100 generates the target block execution code ec. On the contrary, when it is determined that a block has been the target block, the simulation apparatus 100 does not generate the target block execution code ec. The execution code ec is not generated multiple times for the same block, saving space on the memory in estimating the performance value.

For each detected internal state 1600, the first block 3100-1 has association information 2300-1-A to 2300-1-C, and the second block 3100-2 has 2300-2-x to 2300-2-z. In the case where the detected internal state 1600 is the same as the internal state 1600 detected when the block has been previously the target block, the simulation apparatus 100 does not generate the association information 2300 that associates the newly detected internal state 1600. The association information 2300 that associates the same internal state 1600 is not generated multiple times for the same block, saving space on the memory in estimating the performance value.

The simulation apparatus 100 forms a link between the association information 2300 that associates the internal state 1600 of the first block 3100-1 with a performance value 2200, and the association information 2300 generated when the second block 3100-2 to be executed next was executed. Specifically, each piece of the association information 2300 has a next block pointer 3300 and a next association information pointer 3400 in addition to the internal state 1600 and the performance value 2200.

The next block pointer 3300 is an address indicating a storage region (block information storage region 213) in which the execution code ec of the next block is stored. The next association information pointer 3400 is an address indicating a storage region (block information storage region 213) in which the association information 2300 of the next block is stored.

In the example illustrated in FIG. 4, the pointer of the execution code ec-2 in the second block 3100-2 is set as the next block pointer 3300 in the association information 2300-1-A. The association information 2300-2-x in the second block 3100-2 is set as the next association information pointer 3400 in the association information 2300-1-A.

The simulation apparatus 100 acquires the internal state 1600 indicated in the association information 2300 in the second block 3100-2, which is linked with the association information 2300 in the first block 3100-1. Then, the simulation apparatus 100 determines whether or not the internal state 1600 acquired based on the association information 2300 in the first block 3100-1 matches the internal state 1600 detected when the second block 3100-2 was the target block. When the internal states match each other, the simulation apparatus 100 executes the execution code ec of the second block by using the association information 2300 in the second block 3100-2, which is linked with the association information 2300 in the first block 3100-1.

By linking the association information 2300 to be highly likely to be used, processing of searching for the existing association information 2300 that associates the detected internal state 1600 can be accelerated.

Next, software modules of the simulation apparatus 100 in FIG. 1 will be described.

[Software Module Block Diagram]

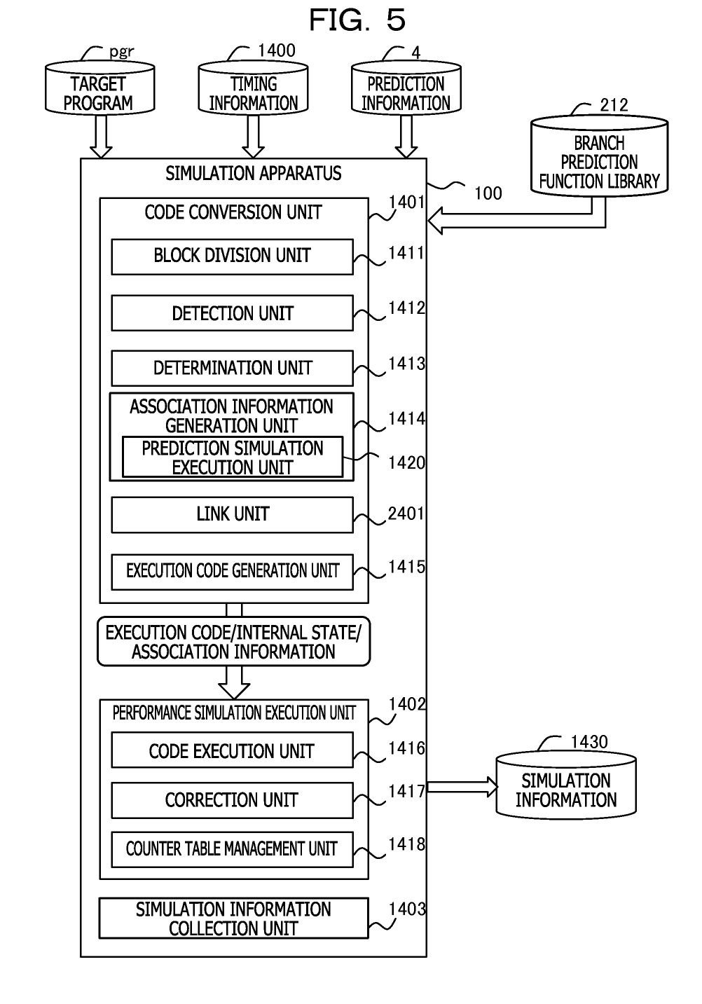

FIG. 5 is a view illustrating software module structure of the simulation apparatus 100 in this embodiment. The simulation apparatus 100 includes a code conversion module 1401, a performance simulation execution module 1402, and a simulation information collection module 1403.

The simulation apparatus 100 obtains the target program pgr, the timing information 1400, and prediction information 4, and outputs simulation information 1430. The target program pgr, the timing information 1400, and the prediction information 4 are stored in a memory such as the RAM 203 and the disk 205. The information may be inputted by use of the input unit 207, or may be acquired from another apparatus via the network NET.

The code conversion module 1401 will be hereinafter referred to as a code conversion unit 1401. The performance simulation execution module 1402 will be hereinafter referred to as a performance simulation execution unit 1402. The simulation information collection module 1403 will be hereinafter referred to as a simulation information collection unit 1403.

For example, processing from the code conversion unit 1401 to the simulation information collection unit 1403 is coded in the simulation program 210 described with reference to FIG. 1. Then, the host CPU 201 reads the simulation program 210 stored in the memory, and executes the processing coded in the simulation program 210. This can achieve the processing from the code conversion unit 1401 to the simulation information collection unit 1403. A processing result of each unit is stored, for example, in the memory such as the RAM 203 and the disk 205.

First, the code conversion unit 1401, the performance simulation execution unit 1402, and the simulation information collection unit 1403 will be summarized.

The code conversion unit 1401 executes the code conversion processing 1401x in FIG. 3. As described above with reference to FIG. 3 and FIG. 4, the code conversion unit 1401 generates the association information 2300 that associates the internal state 1600 with the performance value and the execution code ec that can calculate the performance value 2200 acquired when the target CPU 1200 executes the target block based on the association information 2300.

The performance simulation execution unit 1402 executes the performance simulation execution processing 1402x in FIG. 3. The performance simulation execution unit 1402 executes the execution code ec, thereby calculating the performance value acquired when the target CPU 1200 executes the target block.

The simulation information collection unit 1403 collects the simulation information 1430 that is log information including a run time of each instruction, as an execution result of the performance simulation execution unit 1402. The simulation information 1430 may be stored in a memory such as the disk 205, outputted on the output unit 208 (FIG. 1) such as a display, or outputted to another apparatus via the network NET.

[Description of Input Data]

An example of the target program pgr, the timing information 1400, and the prediction information 4, which are inputs to the simulation apparatus 100, will be described. First, an example of instructions of the block in the target program pgr.

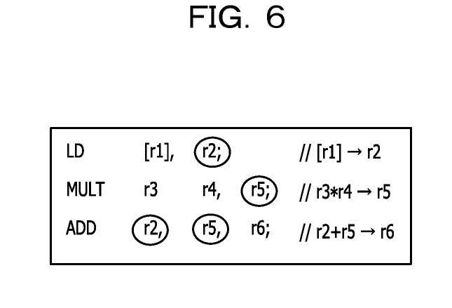

FIG. 6 is a view illustrating an example of the instructions. As illustrated in FIG. 4, a certain block has three instructions of the target code; (1) “LDr1, r2” (load); (2) “MULTr3, r4, r5 (multiplication)”; (3) “ADDr2, r5, r6 (addition)”. It is assumed that the instructions (1) to (3) of the block are put into a pipeline of the target CPU and executed in this order. r1 to r6 of the instructions represent registers (addresses).

The timing information 1400 includes information on correspondence between each processing element (stage) at execution of the instruction and the available register for each instruction of the target code, and information on penalty time (the number of penalty cycles) that is delay time corresponding to the execution result for each external dependence instruction. The external dependence instruction is an instruction to execute processing related to an external hardware resource that can be accessed from the target CPU 1200. Specifically, like a load instruction and a store instruction, the external dependence instruction relates to processing that has its execution result depending on the external hardware resource of the target CPU 1200, for example, instruction cache, data cache, and TLB search. The external dependence instruction is an instruction to execute processing such as branch prediction and call/return stacking.

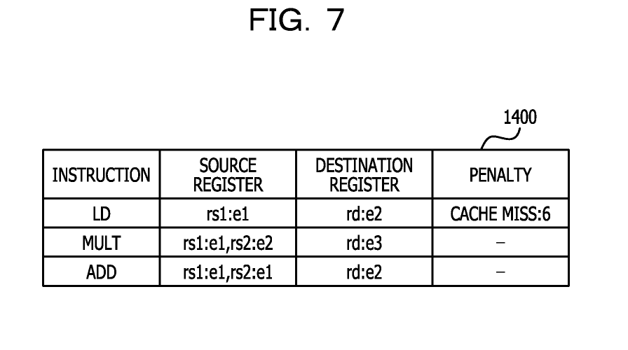

FIG. 7 is a view illustrating an example of the timing information 1400 on each instruction included in the block in FIG. 6. For an LD instruction, the timing information 1400 in FIG. 7 indicates that a source register rs1 (r1) can be used in a first processing element (e1), and a destination register rd (r2) can be used in a second processing element (e2). For a MULTI instruction, a first source register rs1 (r3) can be used in a first processing element (e1), a second source register rs2 (r4) can be used in the second processing element (e2), and a destination register rd (r5) can be used in a third processing element (e3). For an ADD instruction, the first source register rs1 (r2) and the second source register rs2 (r5) can be used in the first processing element (e1), and the destination register rd (r6) can be used in the second processing element (e2).

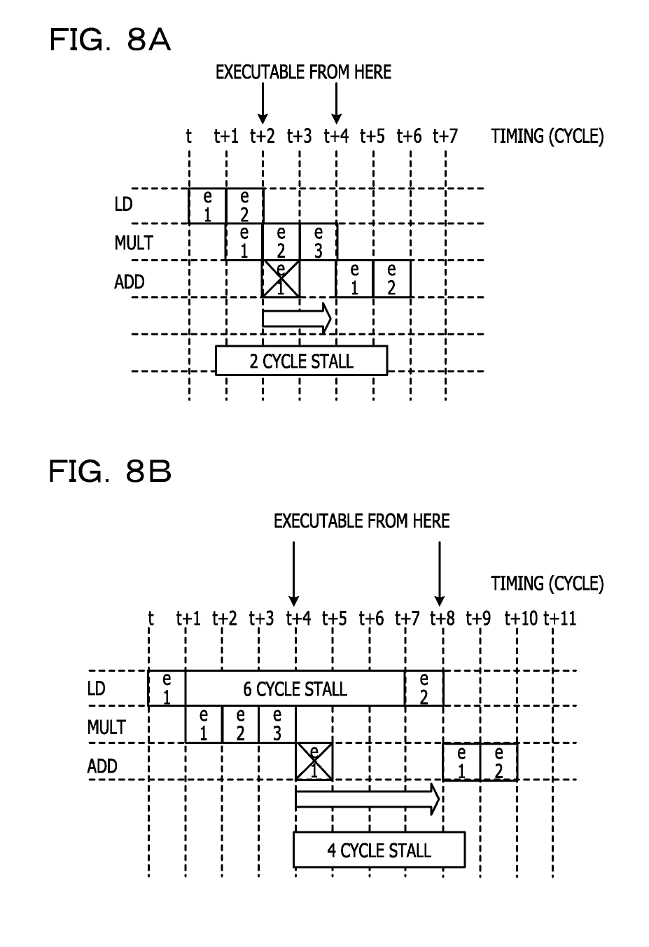

FIGS. 8A and 8B are views illustrating execution timing of each instruction in the block in FIG. 6. Concerning the timing at which each instruction is put into the pipeline from the timing information 1400 in FIG. 7, given that start of execution of the LD instruction is timing t, start of execution of the MULTI instruction becomes timing t+1, and start of execution of the ADD instruction becomes timing t+2. Since the first source register (r2) and the second source register (r5) of the ADD instruction are used for the LD instruction and the MULTI instruction, the ADD instruction starts from timing t+4 at end of execution of the LD instruction and the MULTI instruction onward, generating wait time of 2 cycles (stall of 2 cycles).

Accordingly, as illustrated in FIG. 8A, when the block in FIG. 6 is simulated, in the case where the execution result of the LD instruction is cache hit, the run time of the block is 6 cycles. FIG. 8B illustrates a timing example in the case where the execution result of the LD instruction in the block in FIG. 5 is cache miss. When the result of the LD instruction is cache miss, any sufficient time for reexecution (here, 6 cycles) as penalty is set in the timing information 1400 and thus, the penalty cycle is added as delay time. Accordingly, execution of the second processing element (e2) is delayed to timing t+7. Although the MULTI instruction executed next to the LD instruction is executed without being affected by delay, the ADD instruction starts at timing t+8 at completion of execution of the LD instruction onward, generating wait time of 4 cycles (stall of 4 cycles).

Accordingly, as illustrated in FIG. 8B, when execution of the instructions in the block in FIG. 6 is simulated, in the case where the execution result of the LD instruction is cache miss, the run time is 10 cycles. The prediction information 4 is information indicating a probable execution result (prediction result) in processing of the external dependence instruction of the target code. For example, the prediction information 4 indicates

“instruction cache: prediction=hit,

data cache: prediction=hit,

TLB search: prediction=hit,

branch prediction: prediction=hit,

call/return: prediction=hit, . . . ”.

[Code Conversion Processing of Simulation Apparatus 100]

Returning to FIG. 5, processing of the modules of the code conversion unit 1401 will be sequentially described. The code conversion unit 1401 includes a block division module 1411, a detection module 1412, a determination module 1413, an association information generation module 1414, an execution code generation module 1415, and a link module 2401.

The block division module 1411 will be hereinafter referred to as a block division unit 1411. The detection module 1412 will be hereinafter referred to as a detection unit 1412. The determination module 1413 will be hereinafter referred to as a determination unit 1413. The association information generation module 1414 will be hereinafter referred to as an association information generation unit 1414. The execution code generation module 1415 will be hereinafter referred to as an execution code generation unit 1415. The link module 2401 will be hereinafter referred to as a link unit 2401.

The block division unit 1411 in FIG. 5 divides the code of the target program pgr in FIG. 3, which is inputted to the simulation apparatus 100, into blocks (g1 to g4 in FIG. 3) according to a predetermined standard. For example, the code is divided when the target block changes. A block division unit is as described with reference to FIG. 3.

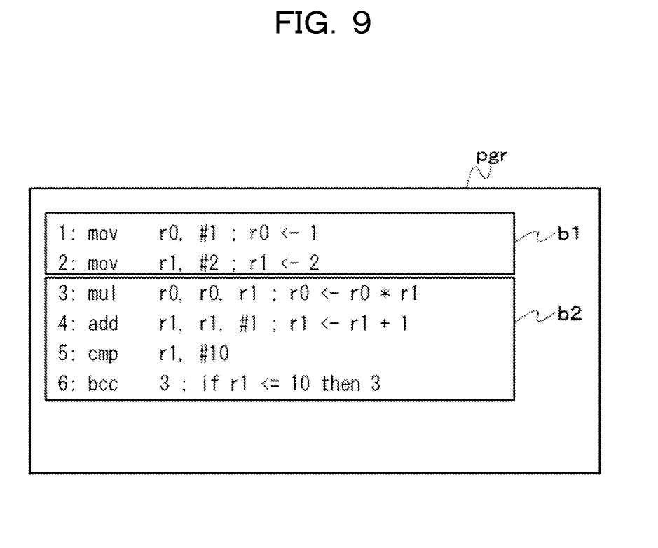

FIG. 9 is a view illustrating an example of blocks of the target program. The example illustrated in FIG. 9 is the target program pgr of finding a calculation result of 1×2×3×4×5×6×7×8×9×10, lines 1 and 2 represent an initialized block b1, and lines 3 to 6 represent a block b2 of a loop body. Specifically, lines 1 and 2 represent processing of initializing a register r0 to a value “1” and a register r1 to a value “2”. The line 3 represents processing of substituting multiplication values of the registers r1, r2 into the register r0. The line 4 represents processing of incrementing the register r1. The lines 5 and 6 represent processing of returning to the line 3 when the value of the register r1 is “10” or less.

The detection unit 1412 in FIG. 5 detects the internal state 1600 (FIG. 3) of the target CPU 1200 in the operational simulation sim when the target block for the operational simulation sim among blocks obtained by dividing the code of the target program pgr. The internal state 1600 is a detection result including the instruction queue 1209, the execution units 1206, and the reorder buffer 1207 in the target CPU 1200 in FIG. 2.

Specifically, for example, when the value of the PC 1201 in the operational simulation sim indicates the address of the instruction included in the next block, the detection unit 1412 detects the internal state 1600 of the target CPU 1200 in the operational simulation sim. For example, a block changes to another block.

The determination unit 1413 in FIG. 5 determines whether or not the target block has previously become the target block, when the target block changes. Specifically, for example, the determination unit 1413 determines whether or not the execution code ec of target block is stored in a memory such as the disk 205. When the block has previously become the target block, the target block has already complied and thus, the execution code ec of the target block is stored in the memory such as the disk 205. On the contrary, when the block has not been the target block, the target block has not been compiled and thus, the execution code ec of the target block is not stored in the memory such as the disk 205.

When the determination unit 1413 determines that the block has not been the target block, the execution code generation unit 1415 in FIG. 5 generates the execution code ec. The generated execution code ec is stored in the block information storage region 213 in FIG. 1. On the contrary, when determination unit 1413 determines that the block has previously become the target block, the execution code generation unit 1415 does not generate the execution code ec. Since the execution code ec is not generated multiple times for each block, as compared to the case where the execution code ec of the target block is generated for each internal state 1600, space on the memory in estimating the performance value of the target block can be saved.

For example, a timing code of the execution code ec includes a code that acquires a performance value from the association information 2300 that associates the internal state 1600 and a code that calculates a performance value expected when the target CPU 1200 executes the target block from the acquired performance value.

FIG. 10 is a table illustrating an example of the execution code. The execution code ec illustrates an example of an x86 instruction. The execution code ec includes a function code acquired by compiling the target program pgr (FIG. 9) and a timing code. The function code are lines 1 to 3 and 8 in the execution code ec. The timing code is lines 4 to 7 of the execution code ec. A state in the execution code ec represents an index (internal state A=0, B=1, . . . ) of the internal state 1600 of the target CPU 1200, and perf1 represents an address at which the performance value of Instruction 1 is stored. When the execution code ec is executed, using the detected internal state 1600 as an argument, the performance value of each instruction is acquired from the association information 2300 in the executing order.

As described above with reference to FIG. 3 and FIG. 4, the association information generation unit 1414 in FIG. 5 generates the association information 2300 that associates the internal state 1600 detected by the detection unit 1412 with the performance value 2200 of each instruction included in the target block in the detected internal state 1600. The association information generation unit 1414 has a prediction simulation execution module (referred to as a prediction simulation execution unit) 1420.

Specifically, the association information generation unit 1414 detects a state dependence instruction that can be branched into multiple types of processing according to the state at execution from the instruction group in the target block. The state dependence instruction is the same as the above-mentioned external dependence instruction, and will be hereinafter referred to as external dependence instruction.

Then, in the first processing among multiple types of processing of the detected external dependence instruction, the prediction simulation execution unit 1420 performs static timing analysis according to the detected internal state 1600 and the performance value 2200 as a reference of each instruction of the target block. Thus, the association information generation unit 1414 calculates the performance value of each instruction included in the target block n the first processing among multiple types of processing of the detected external dependence instruction. The first processing of the external dependence instruction is defined in the inputted prediction information 4. For example, the first processing is the most probable processing in the multiple types of processing. The first processing is referred to as predicted case. It is assumed that the predicted case is previously registered in the prediction information 4.

The performance value as a reference is included in the inputted timing information 1400 (FIG. 7). The timing information 1400 includes the performance value as a reference of each instruction included in the target program pgr, and like the timing information 1400, also includes the penalty performance value used by a correction unit 1417. The association information generation unit 1414 can determine dependence between instructions in the block, that is, the executing order of instructions according to the internal state 1600.

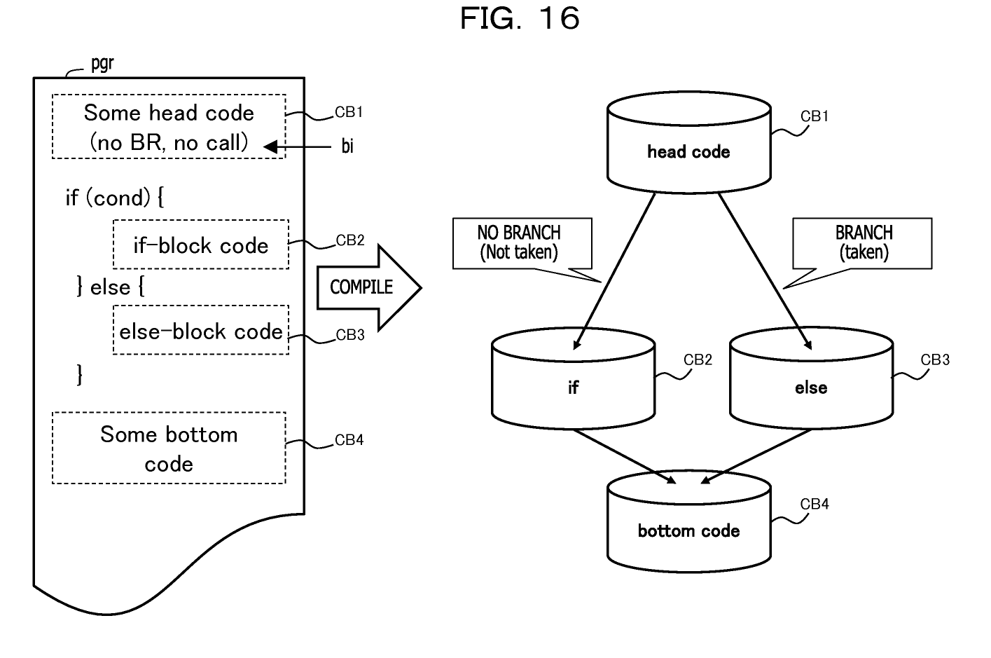

In the example of the internal state 1600 in FIG. 16, the association information generation unit 1414 can determine that the instruction preceding the target block uses the execution unit 1206. Thus, the association information generation unit 1414 adds or subtracts the performance value to or from the performance value 2200 that is a reference of each instruction included in the target block in the executing order of instructions according to the internal state 1600, thereby calculating the performance value of each instruction included in the target block.

Then, the association information generation unit 1414 generates the association information 2300 that associates the detected internal state 1600 with the performance value 2200 of each instruction included in the calculated target block in the internal state 1600. Here, the generated association information 2300 is added to a performance value table of the target block, and is stored in the block information storage region 213 in FIG. 1.

When the target block changes from a first block to a second block, the link unit 2401 in FIG. 5 links the association information 2300 of the first block with the association information 2300 of the second block. Specifically, the link unit 2401 links the association information 2300 of the first block with a pointer 3300 of the second block and a pointer 3400 of the association information 2300 of the second block generated by the association information generation unit 1414.

FIG. 11 illustrates an example of the performance value table. A performance value table 2500 has fields for the internal state 1600, the instruction, the performance value 2200, the next block pointer 3300, and the next association information pointer 3400. By setting information in each field, the association information 2300 is stored as a record. By setting information in each field, the performance value table 2500 is generated as the association information 2300 (2300-A, 2300-B).

In the association information 2300-A on an internal state A, the performance value of Instruction 1 in the internal state A is 2 clocks. In the association information 2300-B on an internal state B, the performance value 2200 of Instruction 1 in the internal state B is 4 clocks. Although FIG. 11 illustrates only the performance value 2200 of Instruction 1, the association information 2300 actually includes the performance value 2200 of each instruction included in the function code.

The performance value table 2500 of FIG. 11 is formed for each concerned block such that the pointer of a next block that was the next target block when the concerned block became the target block previously is set in the field of the next block pointer 3300, and the pointer of the association information 2300 used when the next block became the target block is set in the field of the next association information pointer 3400.

In the association information 2300-A in FIG. 11, “0x80005000” is set in the field of the next block pointer 3300, and “0x80006000” is set in the field of the next association information pointer 3400. In the association information 2300-B, “0x80001000” is set in the field of the next block pointer 3300, and “0x80001500” is set in the field of the next association information pointer 3400.

For example, offset from the next association information 2300 may be set in the field of the next association information pointer 3400. For example, the offset is a difference between the next block pointer and the pointer of the next association information 2300. For example, in the association information 2300-A, “0x80005000” is set in the field of the next block pointer 3300, and “0x1000” is set in the field of the next association information pointer 3400. Thereby, the pointer of the next association information 2300 is determined as “0x80006000”.

For example, in the association information 2300-B, “0x80001000” is set in the field of the next block pointer 3300, and “0x500” is set in the field of the next association information pointer 3400. Thereby, the next association information pointer 3400 is determined as “0x80001500”. By setting the offset from the next association information 2300, the amount of the association information 2300 can be reduced to save space on the memory.

For example, when the target block changes from a third block to a fourth block, the determination unit 1413 determines whether or not the next block pointer 3300 of the association information 2300 of the third block matches the pointer of the fourth block. When they match each other, the determination unit 1413 acquires the internal state 1600 associated by the association information 2300, which is indicated by the next association information pointer 3400 of the association information 2300 of the third block. Then, the determination unit 1413 determines whether or not the internal state 1600 acquired based on the association information 2300 of the third block matches the internal state 1600 of the fourth block, which is detected by the detection unit 1412. When it is determined that the internal states match each other, the performance simulation execution unit 1402 executes the fourth block execution code ec by using the association information 2300 linked with the association information 2300 of the third block.

By linking the association information 2300 to be highly likely to be used in this manner, the processing of searching for the association information 2300 that associates the internal state 1600 detected in the performance value table 2500 can be accelerated.

[Description of Performance Simulation Execution Processing]

Returning to FIG. 5, processing of the performance simulation execution unit 1402 will be sequentially described. The performance simulation execution unit 1402 includes a code execution module 1416, a correction module 1417, and a counter table management module 1418. The code execution module 1416 will be hereinafter referred to as a code execution unit 1416. The correction module 1417 will be hereinafter referred to as the correction unit 1417. The counter table management module 1418 will be hereinafter referred to as a counter table management unit 1418.

The code execution unit 1416 executes the execution code ec by using the association information 2300 generated by the association information generation unit 1414. When it is determined that the block has previously become the target block and the internal state 1600 detected when the block became the target block is the same as the detected internal state 1600, the code execution unit 1416 acquires the association information 2300 that associates the same internal state 1600. Then, the code execution unit 1416 executes the execution code ec by using the acquired association information 2300.

In the execution result obtained when the code execution unit 1416 executes the execution code ec, when the external dependence instruction is second processing that is different from the predicted case among the multiple types of processing, the correction unit 1417 corrects the performance value of the external dependence instruction according to a predetermined performance value corresponding to the second processing. Thereby, the correction unit 1417 calculates the performance value acquired when the target CPU 1200 executes the target block. Detailed correction method of the correction unit 1417 is disclosed in Japanese Laid-open Patent Publication No. 2013-84178.

During simulation, the counter table management unit 1418 generates a counter table that predicts branch of a branch instruction, and predicts the branch of the branch instruction according to the counter table.

The counter table management unit 1418 corresponding a model of the target CPU 1200 that is a branch predicting function model embodied as the branch predicting function library 212 (FIG. 1). The branch predicting function model is, for example, a behavior model that produces only a system function by using the hardware description language or the like. The counter table management unit 1418 updates the counter table each time the branch instruction is executed by the code execution unit 1416. Details of processing of the counter table and the counter table management unit 1418 will be described later.

As described above with reference to FIG. 1 to FIG. 11, the simulation apparatus 100 in this embodiment detects the internal state 1600 of the target CPU in the case where the target block for operational simulation changes. Then, the simulation apparatus 100 sequentially generates the execution code ec (FIG. 10) for the target block and the association information 2300 (FIG. 11) for each detected internal state 1600, and stores them in the block information storage region 213 (FIG. 1). Then, the simulation apparatus 100 executes using the execution code ec using the association information 2300 corresponding to the detected internal state 1600 to calculate the performance value of the target block.

As illustrated in FIG. 4, the simulation apparatus 100 generates the association information 2300 for each detected internal state 1600 in addition to the target block execution code ec, and stores the association information 2300 in the block information storage region 213. The simulation apparatus 100 stores a pointer 3300 indicating a next block and a pointer 3400 indicating the association information 2300 as a first candidate for the next block in the association information 2300. This accelerates processing of searching for the association information 2300.

By improving the accuracy of the simulation processing, the data amount of the association information 2300 increases. That is, the data amount of the block information 3100 (execution code ec and association information 2300) increases. Accordingly, as the simulation apparatus 100 sequentially executes the performance simulation processing, free space in the block information storage region 213 rapidly decreases. As a result, the simulation apparatus 100 may not store new execution code ec and association information 2300 in the block information storage region 213.

Thus, to increase free space in the block information storage region 213, the execution code ec and the association information 2300, which are stored in the block information storage region 213, can be deleted. However, when the frequently executed block execution code ec is deleted, in the case where the block becomes the target block again, recompiling is desired. Recompiling decreases the simulation speed. When the association information 2300 of the frequently executed block is deleted, the association information 2300 of the target block has to be regenerated. Regeneration of the association information 2300 further decreases the simulation speed.

It is difficult to detect the block information 3100 to be deleted from the block information 3100 of many blocks in FIG. 3 stored in the block information storage region 213. Further, it takes time to detect the block information 3100 to be deleted from the block information 3100 of many blocks.

Accordingly, the simulation apparatus 100 in this embodiment deletes the block information 3100 of the block selected from among a plurality of blocks based on the probability of execution in response to a branch in a preceding block, depending on free space in the block information storage region 213. Specifically, the simulation apparatus 100 selects the block having the lowest probability of execution in response to a branch in the preceding block from among the plurality of blocks.

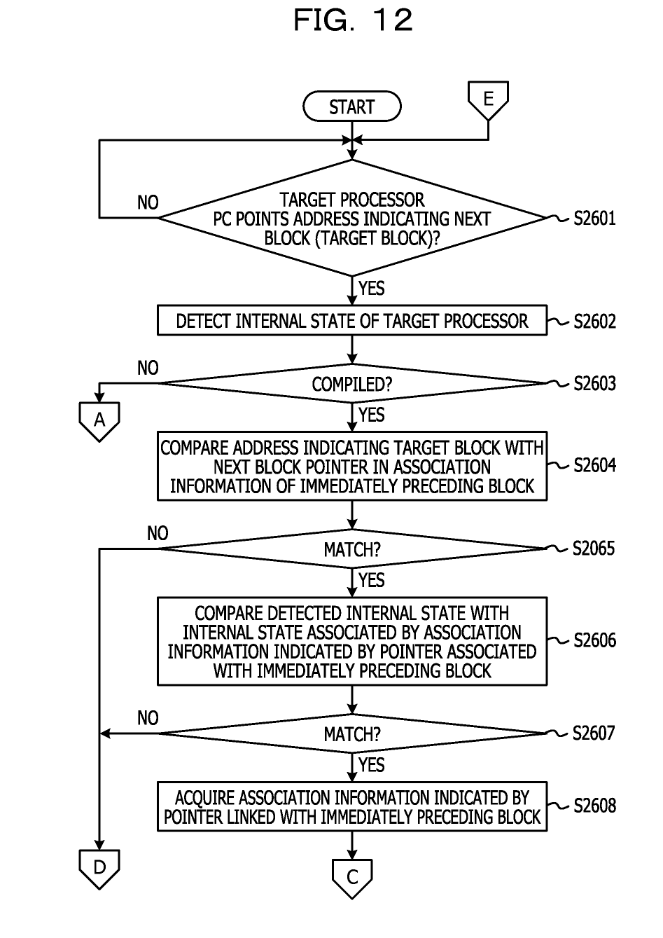

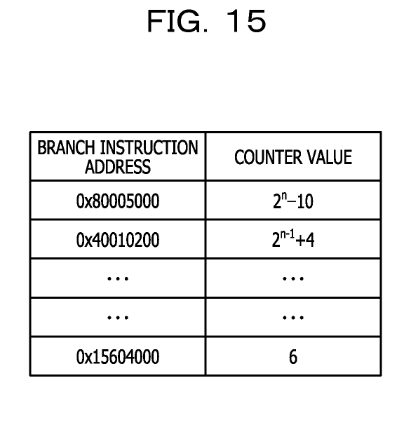

Next, the processing of the simulation apparatus 100 described with reference to FIG. 1 to FIG. 11 will be described below using flow charts in FIG. 12 to FIG. 14. After that, processing of selecting the block with the block information 3100 to be deleted will be described with reference to FIG. 15 to FIG. 19.

[Flow Chart of Simulation Apparatus 100]

FIG. 12 to FIG. 14 are flow charts illustrating an example of the simulation processing of the simulation apparatus in this embodiment. In the flow chart in FIG. 12, first, the detection unit 1412 determines whether or not the PC 1201 of the target CPU 1200 points an address representing the next block (target block) (Step S2601). The detection unit 1412 determines whether or not the target block changes in Step S2601.

When the address representing the next block (target block) is not pointed (Step S2601: No), the detection unit 1412 returns to Step S2601. On the contrary, when the address representing the next block (target block) is pointed (Step S2601: Yes), the detection unit 1412 detects the internal state 1600 of the target CPU 1200 (Step S2602). Next, the determination unit 1413 determines whether or not the target block has been compiled (Step S2603).

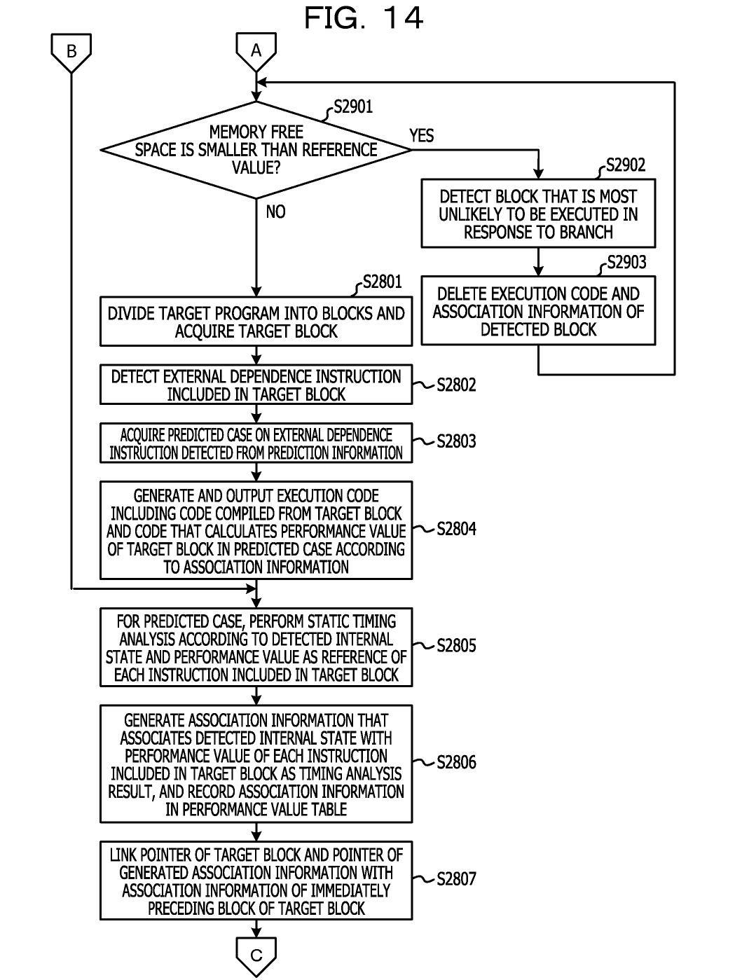

When it is determined that the target block has not been compiled (Step S2603: No), the determination unit 1413 proceeds to the flow chart in FIG. 14, and determines whether or not free space on the memory (block information storage region 213 of the RAM 203) of the simulation apparatus 100 is smaller than a reference value of the determination unit 1413 (Step S2901). When the free space is smaller than the reference value (Step S2901: Yes), the capacity of the block information storage region 213 may lack such that the block information storage region 213 does not store new execution code ec and association information 2300.

Accordingly, the determination unit 1413 detects and selects the block that is the most unlikely to be executed in response to a branch according to the branch predicting function (Step S2902). That is, the determination unit 1413 detects the block that has been previously processed and is less likely to be executed. Details processing in Step S2902 will be described later using flow charts in FIG. 15 to FIG. 18. Then, the determination unit 1413 deletes the execution code ec and the association information 2300 of the selected block from the block information storage region 213 (Step S2903).

For example, the reference value corresponds to size of the block information 3100 of one block. However, the reference value is not limited to this, and may be set to any value. In this example, when the new target block execution code ec is generated, free space of the block information storage region 213 is determined, but the embodiment is not limited to this. The simulation apparatus 100 may periodically determine free space of the block information storage region 213.

On the contrary, when free space on the memory is the reference value or more (Step S2901: No), the block division unit 1411 divides the target program pgr to acquire the target block (Step S2801). The association information generation unit 1414 detects the external dependence instruction included in the target block (Step S2802), and acquires the predicted case of the external dependence instruction detected from the prediction information 4 (Step S2803).

Next, the execution code generation unit 1415 generates and outputs the execution code ec including the function code c1 compiled from the target block and the timing code c2 that calculates the performance value of the target block in the predicted case according to the association information 2300 (Step S2804). The performance value of the target block in the predicted case refers to the performance value of the target block in the predicted case acquired by the detected external dependence instruction.

On the predicted case, the prediction simulation execution unit 1420 performs static timing analysis according to the detected internal state 1600 and the performance value 2200 as a reference of each instruction included in the target block (Step S2805). The association information generation unit 1414 generates the association information 2300 that associates the detected internal state 1600 with the performance value of each instruction included in the target block as a timing analysis result, and records the association information 2300 in the performance value table 2500 (FIG. 11) (Step S2806). Association information 101 in the same internal state 1600 is generated only once. Thus, even when the same internal state 1600 is detected multiple times for the target block, space on the memory in estimating the performance value of the target block can be saved.

Then, the link unit 2401 links the pointer of the target block and the pointer of the generated association information 2300 with the association information 2300 of the immediately preceding block of the target block (Step S2807), and proceeds to Step S2707 in the flow chart in FIG. 12. The association information 2300 of the immediately preceding block of the target block is the association information 2300 used to calculate the performance value of the immediately preceding block of the target block.

Returning to the flow chart in FIG. 12, when it is determined that the target block is compiled (Step S2603: Yes), the determination unit 1413 compares the address indicating the target block with the next block pointer 3300 of the association information 2300 of the immediately preceding block (Step S2604). The address indicating the target block is an address of a storage region in which the target block execution code ec is stored (block information storage region 213).

That is, when the target block changes from the third block to the fourth block, the determination unit 1413 refers to the association information 2300, and determines whether or not the third block has previously changed to the fourth block. Specifically, the determination unit 1413 determines whether or not the next block pointer 3300 included in the association information 2300 of the third block matches the pointer of the fourth block.

When it is determined that the pointers match each other (Step S2605: Yes), the determination unit 1413 acquires the association information 2300 indicated by the pointer 3400 linked by the association information 2300 of the immediately preceding block. Then, the determination unit 1413 compares the internal state 1600 associated by the association information 2300 acquired based on the immediately preceding block with the detected internal state 1600 (Step S2606). When it is determined that the pointers match each other, the determination unit 1413 determines that the third block has previously changed to the fourth block.

That is, when the fourth block has previously become the target block, the determination unit 1413 acquires the association information 2300 linked with the association information 2300 of the third block. Then, the determination unit 1413 determines whether or not the internal state 1600 associated by the association information 2300 acquired based on the third block with the internal state 1600 detected on the fourth block. That is, the determination unit 1413 determines whether or not the internal state 1600 associated by the association information 2300, which is indicated by the pointer 3400 of the association information of the association information 2300 of the third block, matches the internal state 1600 on the fourth block, which is detected by the detection unit 1412.

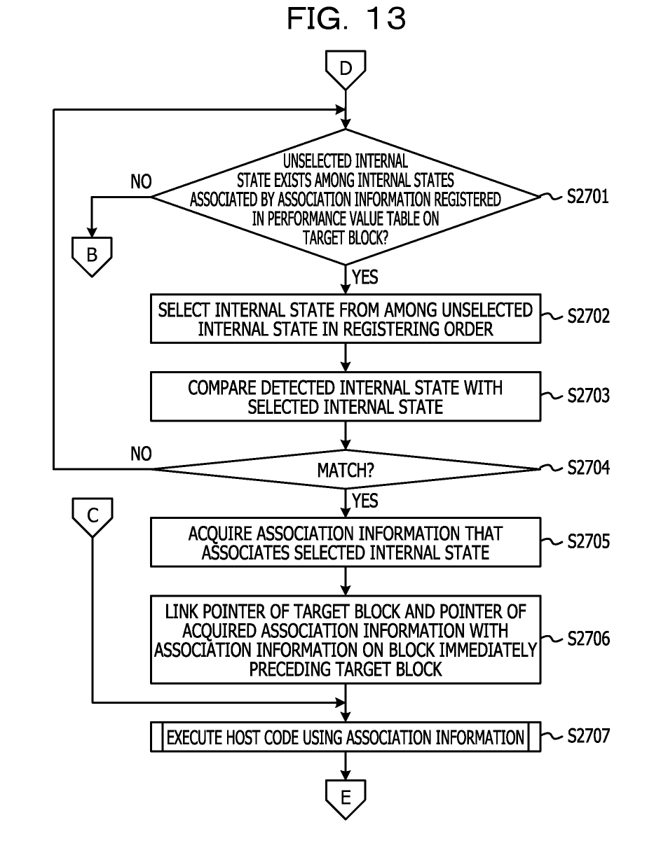

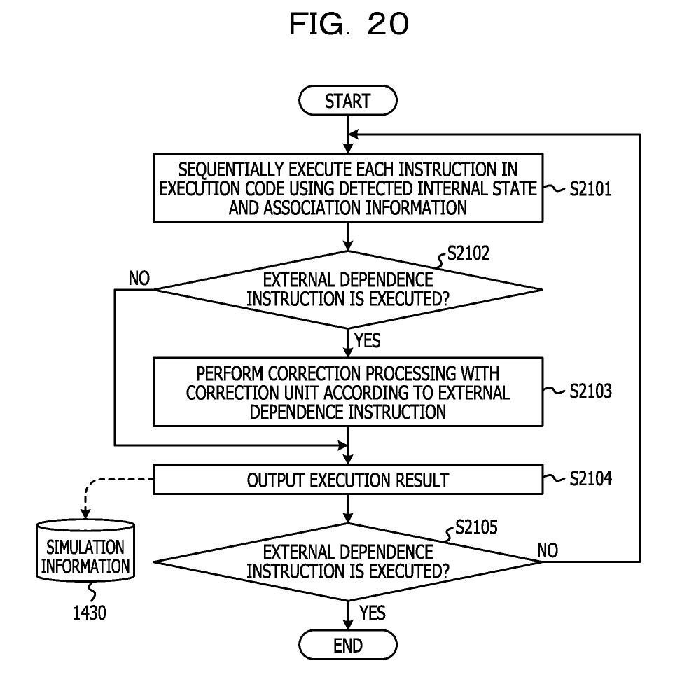

When they match each other (Step S2607: Yes), the determination unit 1413 acquires the association information 2300 indicated by the pointer 3300 linked with the immediately preceding block (Step S2608), and proceeds to Step S2707 in the flow chart in FIG. 13. That is, the performance simulation execution unit 1402 executes the execution code ec of the fourth block by using the association information 2300 of the fourth block linked with the association information 2300 of the third block. Details of the processing will be described later using a flow chart in FIG. 20.

As described above, the simulation apparatus 100 in this embodiment links the association information 2300 being highly likely to be used with the association information 2300 of the immediately preceding block. This can accelerate processing of searching for the association information 2300 that associates the detected internal state 1600 from the performance value table 2500 in FIG. 11.

On the contrary, when it is determined that they don't match each other in Step S2605 (Step S2605: No), or when it is determined that they don't match each other in Step S2607 (Step S2607: No), the determination unit 1413 proceeds to Step S2701 in the flow chart in FIG. 13. In Step S2701 in the flow chart in FIG. 13, the determination unit 1413 determines whether or not there is unselected internal state 1600 among the internal states 1600 associated by the association information 2300 registered in the performance value table 2500 on the target block (Step S2701).

When there is no unselected internal state 1600 (Step S2701: No), the determination unit 1413 proceeds to Step S2805. Then, the association information 2300 that associates the detected internal state 1600 is generated. In this manner, in the target block, the association information 2300 is generated for each detected internal state 1600. The target block execution code ec is generated only once.

When there is unselected internal state 1600 (Step S2701: Yes), the determination unit 1413 selects the unselected internal state 1600 in the registering order (Step S2702). The determination unit 1413 compares the detected internal state 1600 with the selected internal state 1600 (Step S2703). Then, the determination unit 1413 determines whether or not they match each other (Step S2704). When they match each other (Step S2704: Yes), the determination unit 1413 acquires the association information 2300 that associates the selected internal state 1600 from the performance value table 2500 (FIG. 11) (Step S2705).

That is, the determination unit 1413 determines whether or not the detected internal state 1600 is the same as the internal state 1600 detected when the block has previously become the target block. Specifically, using the detected internal state 1600 as a search key, the determination unit 1413 searches for the association information 101 having the internal state 1600 corresponding to the search key from the performance value table 2500. When the association information 101 having the corresponding internal state 1600 is searched out, the determination unit 1413 determines that the internal state 1600 is the same as the internal state 1600 detected when the block has previously become the target block. In this case, the association information generation unit 1414 does not generate new association information 101.

Next, for the immediately preceding block of the target block, the link unit 2401 links the pointer 3300 of the target block and the pointer 3400 of the acquired association information in the association information 2300 (Step S2706). Then, the code execution unit 1416 executes the execution code ec by using the acquired association information 2300 (Step S2707), and returns to Step S2601 in the flow chart in FIG. 12.

On the contrary, when it is determined that the detected internal state 1600 does not match the selected internal state 1600 (Step S2704: No), the simulation apparatus 100 returns to Step S2701. That is, when the association information 101 having the corresponding internal state 1600 is not searched out, the determination unit 1413 determines that the internal state 1600 is not the same as the internal state 1600 detected when the block has previously become the target block. In this case, the association information generation unit 1414 generates new association information 101 based on the newly detected internal state 1600.

[Detection Processing of Block to be Deleted (Step S2902 in FIG. 14)]

As described above using the flow charts in FIG. 12 to FIG. 14, when free space of the block information storage region 213 becomes smaller than the reference value, the determination unit 1413 detects and selects the block that is the most unlikely to be executed in response to a branch (Step S2902). Then, the determination unit 1413 deletes the block information 3100 of the selected block from the block information storage region 213, such that the block information 3100 of a new block can be stored.

The block information to be deleted can be detected according to a Least Recently Used (LRU) algorithm. According to this method, block information of the block that has not been executed for a long time out of the block information stored in the block information storage region 213 is deleted. However, even if the block has not been executed for a long time, the block is likely to be reexecuted. When the block being likely to be reexecuted is deleted, recompile processing of the execution code ec and processing of generating the association information 2300 may occur.

In this embodiment, the determination unit 1413 refers to the counter table (described later with reference to FIG. 15) generated by the counter table management unit 1418 (FIG. 5) to detect the block being less likely to be executed in response to a branch based on a probability of execution in response to a branch in the preceding block. Thereby, the determination unit 1413 can keep the block information 3100 of a block to be highly likely to be executed from being deleted from the memory. Thus, the frequency of performing recompile processing and processing of generating the association information 2300 can be reduced.

Thus, the simulation apparatus 100 in this embodiment can perform highly accurate performance simulation according to the association information 2300 while minimizing recompile processing and processing of generating the association information 2300. That is, the simulation apparatus 100 can keep the execution speed of performance simulation while improving the accuracy of performance simulation.

[Counter Table]

An example of a counter table will be described below with reference to FIG. 15.

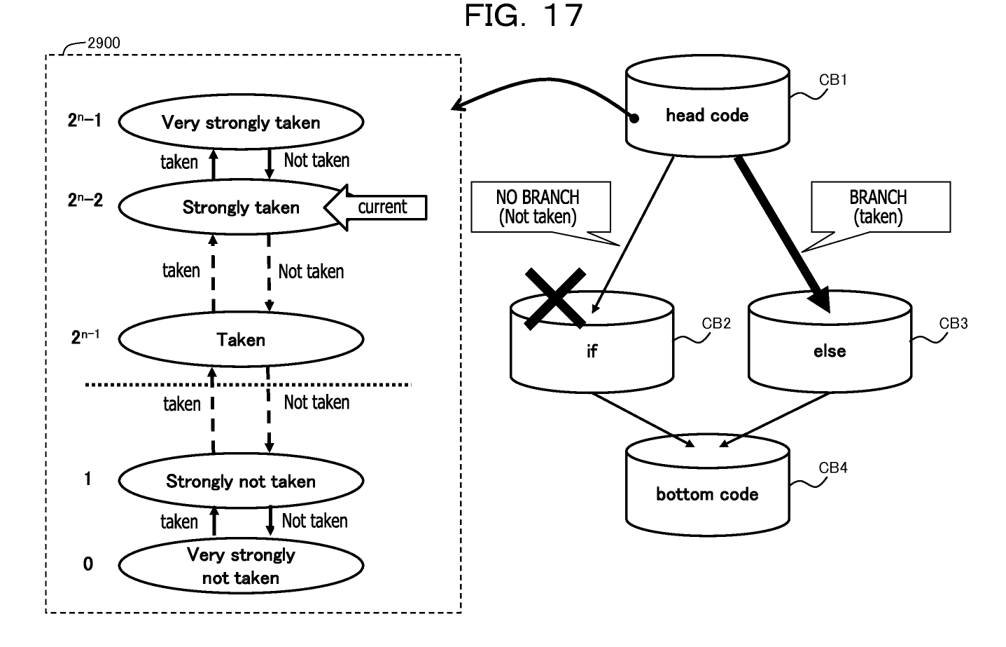

FIG. 15 is a view illustrating an example of a counter table 2800 generated based on a saturating counter (n-bit saturating counter). The counter table management unit 1418 generates the counter table 2800 according to a prediction algorithm of the saturating counter. The algorithm of the saturating counter will be described later with reference to FIG. 16 and FIG. 17. However, the counter table management unit 1418 may generate the counter table 2800 according to another algorithm.

The counter table 2800 in FIG. 15 has an address of the branch instruction and a counter value indicating a possibility of a branch of the branch instruction. Specifically, when the counter value is larger than the reference value“2ⁿ−1”, the possibility that the branch instruction branches is high. When the counter value is smaller than the reference value“2ⁿ−1”, the possibility that the branch instruction does not branch is high. That is, as the counter value is larger than the reference value“2ⁿ−1”, the possibility that the branch instruction branches is higher. On the contrary, as the counter value is smaller than the reference value“2ⁿ−1”, the possibility that the branch instruction does not branch is higher.

During simulation, when detecting the branch instruction in the execution code ec, the counter table management unit 1418 performs branch prediction of the branch instruction according to the counter table 2800. Next, the counter table management unit 1418 compares a prediction result of the branch instruction with a branch result of the branch instruction after execution of the execution code ec by the code execution unit 1416. Then, the counter table management unit 1418 updates the counter value in the counter table 2800 according to a comparison result.

[Algorithm of Saturating Counter]

Next, the algorithm of the saturating counter (n-bit saturating counter) will be summarized. First, branch between blocks will be described.

FIG. 16 is a view illustrating an example of branch between blocks. The target program pgr in FIG. 16 has a branch instruction bi. As described above, the block division unit 1411 (FIG. 5) divides the target program pgr according to the branch instruction bi to generate blocks CB1 to CB4. Specifically, the blocks CB1 has a code group (Some head code) up to the branch instruction. The block CB2 has a code group (if-block code) without branch. The block CB3 has a code group (else-block code) with branch. The block CB4 has a code group (Some bottom code) after branch processing.

The blocks CB1 to CB4 illustrated on the right side in FIG. 16 corresponds to the execution code ec generated by compiling the blocks CB1 to CB4 of the target program pgr. In this example, when branch instruction bi does not branch (Not taken), the block CB2 is executed subsequent to the block CB1. When the branch instruction bi branches (Taken), the block CB3 is executed subsequent to the block CB1. Subsequent to the block CB2 and the block CB3, the block CB4 is executed.

Next, the algorithm of the saturating counter (n-bit saturating counter) will be described based on branch between blocks in FIG. 16 with reference to FIG. 17.

FIG. 17 is a view illustrating the algorithm of the saturating counter. A state transition view 2900 in FIG. 17 illustrates five states of the saturating counter. The five states are a state “2ⁿ−1 branch: Taken”, a state “2ⁿ−2 branch (low possibility): Strongly taken”, a state “2ⁿ−1 branch (high possibility): Very strongly taken”, a state “1 not branch (low possibility): Strongly not taken”, and a state “0 not branch (high possibility): Very strongly not taken”. The state “2ⁿ−1 branch: Taken” represents an initial state. Although the five states are used in this example, the number of states is not limited to five. The number of states increases or decreases depending on a variable n.

The state transition will be described using the branch instruction bi of the block CB1 in FIG. 16. Initially, the state of the branch instruction bi is set to the state “2ⁿ−1: Taken”. When the branch instruction bi branches, the counter table management unit 1418 causes the state of the branch instruction bi to transit to the state “2ⁿ−2: Strongly taken”. On the contrary, when the branch instruction bi does not branch, the counter table management unit 1418 causes the state of the branch instruction bi to transit to the state “1: Strongly not taken”.

Then, in the case where the branch instruction bi is the state “2ⁿ−2: Strongly taken”, when the block CB1 is executed again and the branch instruction bi branches, the counter table management unit 1418 causes the state of the branch instruction bi to transit to the state “2ⁿ−1: Very strongly taken”. Alternatively, in the case where the branch instruction bi is the state “2ⁿ−2: Strongly taken”, when the block CB1 is executed again and the branch instruction bi does not branch, the counter table management unit 1418 causes the state of the branch instruction bi to return to the state “2ⁿ−1: Taken”.

That is, when the block CB1 in FIG. 17 is repeatedly executed and the branch instruction bi branches each time, the counter value of the branch instruction bi increases from an initial value “2ⁿ−1”. On the contrary, when the block CB1 is repeatedly executed and the branch instruction bi does not branch each time, the counter value of the branch instruction bi decreases from the initial value “2ⁿ−1”.

In this manner, the counter table management unit 1418 causes the state of the branch instruction bi to transit according to the branch result. Accordingly, the counter table management unit 1418 generates the counter table 2800 in FIG. 15 having a value of each state of the state transition view 2900 as the counter value. Then, the determination unit 1413 detects a block being less likely to be executed according to the counter table 2800.

Specifically, the counter table management unit 1418 detects the branch instruction and the counter value according to a Least Recently Used (LRU) algorithm. The counter table management unit 1418 deletes the branch instruction that has not been executed for a long time according to the LRU algorithm. Then, the determination unit 1413 adds the block being less likely to be executed from two blocks indicated by the detected branch instruction to a deletion target list based on the counter value.

Specifically, when the counter value indicates a possibility of a branch, the determination unit 1413 detects the block to which the branch instruction corresponding to the counter value proceeds without branching. On the other hand, when the counter value indicates a possibility of no branch, the determination unit 1413 detects the block into which the branch instruction corresponding to the counter value branches.

It is assumed that the determination unit 1413 detects the counter value of the branch instruction bi illustrated in FIG. 17. At this time, when the counter value indicates a possibility of a branch, the determination unit 1413 detects the block CB2 to which the branch instruction bi proceeds without branching from the two blocks CB2, CB3. When the counter value indicates a possibility of no branch, the determination unit 1413 detects the block CB3 to which the branch instruction bi proceeds without branching.

Then, determination unit 1413 sequentially detects the block of the earliest entry of the blocks in the generated deletion target list as a block to be deleted. As described above, the determination unit 1413 detects the block being less likely to be executed of the two blocks indicated by the branch instruction that has not been executed for a long time according to the counter table 2800. Consequently, the determination unit 1413 can properly detect the block being less likely to be executed that has not been executed for a long time.

Further, when there is no entry in the deletion target list, the determination unit 1413 detects the block being less likely to be executed according to the counter value of each branch instruction of the counter table 2800. Note that the determination unit 1413 may detect the block being less likely to be executed according to only the counter value of the branch instruction irrespective of the entry in the deletion target list.

Specifically, the determination unit 1413 detects the counter value having the largest absolute value of the difference between the counter value and the initial value “2ⁿ−1” from the counter table 2800. The branch instruction of the detected counter value has the highest possibility of a branch or no branch. As described above, when the detected counter value indicates a high possibility of a branch, the determination unit 1413 detects the block to which the branch instruction corresponding to the counter value proceeds without branching. On the other hand, when the detected counter value indicates a high possibility of no branch, the determination unit 1413 detects the block into which the branch instruction corresponding to the counter value branches.

As described above, the determination unit 1413 can efficiently detect the block being less likely to be executed based on the counter value in the counter table 2800 as illustrated in FIG. 15. The determination unit 1413 keeps the block information 3100 of the block that has not been executed for a long time, but is likely to be executed from being deleted based on the probability of execution in response to a branch in a preceding block.

Accordingly, in detecting the block that has not been executed for a long time, the block being less likely to be executed can be detected more properly by using the counter table 2800. That is, it is possible to keep the block information 3100 of the block being likely to be reexecuted from being deleted. Consequently, the block information 3100 of the block being likely to be reexecuted can be stored in the block information storage region 213 more reliably.

Therefore, the simulation apparatus 100 in this embodiment can suppress recompile processing and processing of generating the association information 2300, and thus, can suppress a decrease in the simulation speed.

[Flow Chart]

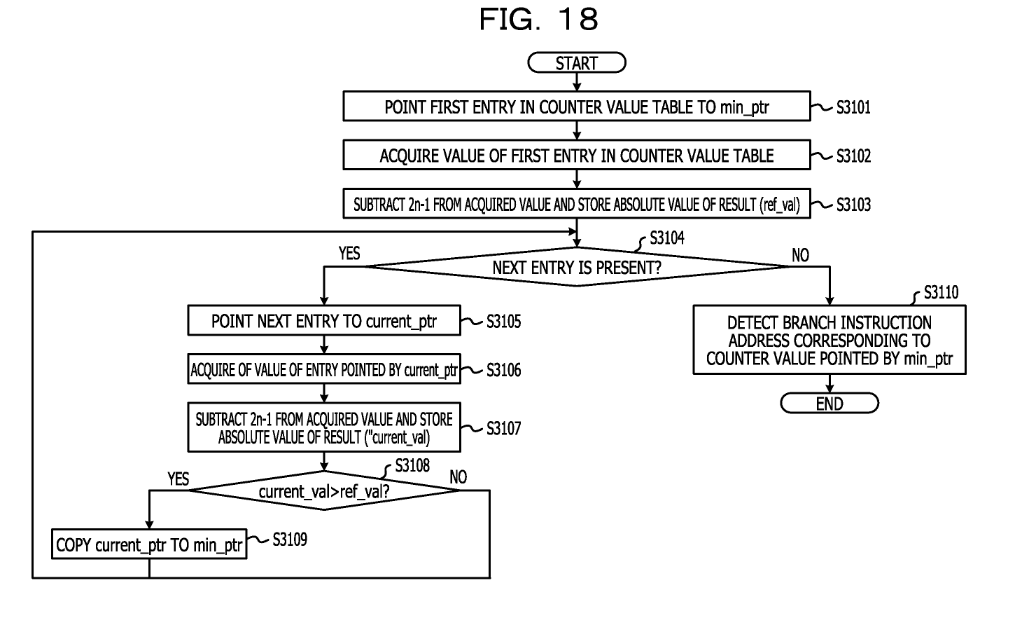

Next, processing in which the determination unit 1413 detects the block to be deleted by referring to the counter value in the counter table 2800 will be described with reference to FIG. 18.

FIG. 18 is a flow chart illustrating the processing of detecting the block to be deleted by referring to the counter table 2800.

Step S3101: The determination unit 1413 refers to the counter table 2800, and causes a pointer “min_ptr” to point the first entry of the counter table 2800.

Step S3102: The determination unit 1413 acquires the counter value of the first entry in the counter table 2800.

Step S3103: The determination unit 1413 stores an absolute value found by subtracting the initial value “2ⁿ−1” from the acquired counter value in a value “ref_val”.

Step S3104: Next, the determination unit 1413 determines whether or not the next entry is present in the counter table 2800.

Step S3105: When the next entry is present (Step S3104: Yes), the determination unit 1413 causes a pointer “current_ptr” to point the next entry.

Step S3106: the determination unit 1413 acquires the counter value of the entry pointed by the pointer “current_ptr”.

Step S3106: The determination unit 1413 stores an absolute value found by subtracting the initial value “2ⁿ−1” from the acquired counter value in a value “current_val”.

Step S3108: Then, determination unit 1413 determines whether or not the absolute value “current_val” of the next entry is larger than the absolute value “ref_val” of the initial entry. That is, the determination unit 1413 compares the absolute value of the first entry with the absolute value of the second entry.

Step S3109: When the absolute value “current_val” of the next entry is larger than the absolute value “ref_val” of the initial entry (Step S3108: Yes), the absolute value of the difference from the initial value “2ⁿ−1” in the next entry is larger than the absolute value of the difference from the initial value “2ⁿ−1” in the initial entry. Accordingly, the determination unit 1413 sets the value of the pointer “current_ptr” indicating the next entry to the pointer “min_ptr” indicating the initial entry.

On the contrary, when the absolute value “current_val” of the next entry is the absolute value “ref_val” of the initial entry or more (Step S3108: No), the determination unit 1413 does not update the pointer “min_ptr” indicating the initial entry.

When an entry is present in the counter table 2800 (Step S3104: Yes), the determination unit 1413 moves the pointer “current_ptr”, and executes processing in Step S3105 to Step S3109. As a result, the pointer “min_ptr” indicates the entry having the largest absolute value in all entries in the counter table 2800.

Step S3110: When an entry lacks (Step S3104: No), the determination unit 1413 detects a branch instruction address of the entry indicated by the pointer “min_ptr”.

Step S3101: When the counter value of the detected branch instruction address is the initial value “2ⁿ−1” or more and thus indicates a high possibility of the branch instruction branching, the determination unit 1413 sets the block to which the branch instruction proceeds without branching as a block to be deleted. On the contrary, when the counter value of the detected branch instruction address is smaller than the initial value “2ⁿ−1” and thus indicates a high possibility of the branch instruction not branching, the determination unit 1413 sets the block to which the branch instruction branches as a block to be deleted.

An specific example in which the block being less likely to be executed is detected using the counter table 2800 in FIG. 15 will be described below. In the specific example, a value n in the counter table 2800 in FIG. 15 is a value “5”.

In the counter table 2800 in FIG. 15, the counter value of the branch instruction having an address “0x80005000” is a value “22 (=2ⁿ−10)”, which exceeds the initial value “16 (=2ⁿ−1)”. That is, the branch instruction having the address “0x80005000” represents a high possibility of a branch. An absolute value of a difference between the counter value and the initial value is a value “6 (=22−16)”. Similarly, the counter value of the branch instruction having an address “0x40010200” is a value “20 (=2ⁿ−1+4)”, which exceeds the initial value “16 (=2ⁿ−1)”. That is, the branch instruction having the address “0x40010200” represents a high possibility of a branch. An absolute value of a difference between the initial value and the counter value is a value “4 (=20−16)”.

The counter value of the branch instruction having an address “0x15604000” is a value “6”, which falls below the initial value “16 (=2ⁿ−1)”. That is, the branch instruction having the address “0x15604000” represents a high possibility of no branch. An absolute value of a difference between the initial value and the counter value is a value “10 (=16−6)”.

Accordingly, the determination unit 1413 detects the branch instruction having the address “0x15604000”, which has the largest absolute value of a difference between the counter value and the initial value. As described above, the counter value “6” of the branch instruction having the address “0x15604000” represents a high possibility of no branch. Accordingly, the determination unit 1413 detects the block into which the branch instruction having the address “0x15604000” branches.

[Description of Branch Prediction Processing]

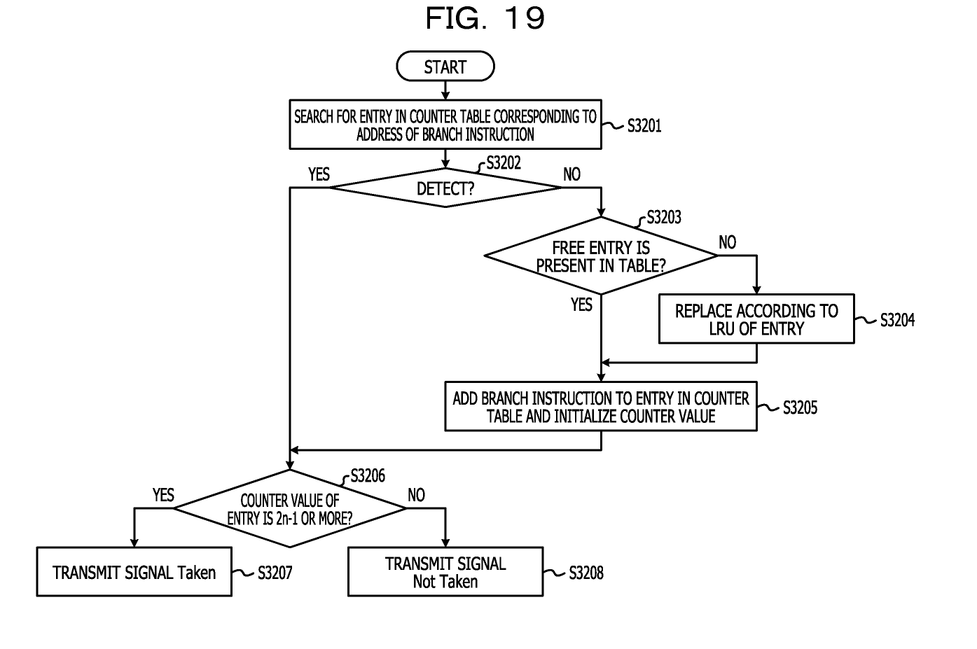

Next, branch prediction processing executed by the counter table management unit 1418 according to the counter table 2800 in FIG. 15 will be described with reference to FIG. 19.

FIG. 19 is a flow chart illustrating the branch prediction processing executed based on the counter table 2800.

Step S3201: The counter table management unit 1418 searches for the entry in the table corresponding to the address of the target branch instruction from the counter table 2800.

Step S3203: When no entry in the table corresponding to the address of the target branch instruction is detected (Step S3202: No), the counter table management unit 1418 determines whether or not a free entry is present in the table. In this case, the block including the target branch instruction is executed for the first time.

Step S3204: When no free entry is present in the table (Step S3203: No), the counter table management unit 1418 deletes the entry that has not been updated for a long time according to the LRU algorithm. As described above, for example, the determination unit 1413 adds the block being less likely to be executed out of the two blocks indicated by the branch instruction of the deleted entry to the deletion target list.

Step S3205: When the free entry is present in the table (Step S3203: Yes), or the entry is deleted (Step S3204), the counter table management unit 1418 adds the target branch instruction to the entry in the counter table 2800. The counter table management unit 1418 sets the counter value of the target branch instruction to the initial value “2ⁿ−1”.

Step S3206: When no entry in the table corresponding to the address of the target branch instruction is detected (Step S3201: Yes), the counter table management unit 1418 determines whether or not the counter value of the entry is larger than the initial value “2ⁿ−1”. Alternatively, when the entry of the target branch instruction is added to the counter table 2800 (Step S3204), the counter table management unit 1418 determines whether or not the counter value of the entry is larger than the initial value “2ⁿ−1”.

Step S3207: When the counter value is the initial value “2ⁿ−1” or more (Step S3206: Yes), the counter table management unit 1418 transmits a signal Taken (branch). That is, the counter table management unit 1418 predicts that the target branch instruction branches.

Step S3208: On the contrary, when the counter value is smaller than the initial value “2ⁿ−1” (Step S3206: No), the counter table management unit 1418 transmits a signal Not Taken (no branch). That is, the counter table management unit 1418 predicts that the target branch instruction does not branch.

As described above, the simulation apparatus 100 can efficiently detect the block being less likely to be executed by using the counter table 2800 generated by the branch predicting function that is an existing function of the processor. The branch predicting function is previously equipped in a simulator. Consequently, generation of the counter table 2800 does not exert any additional load on the simulation processing.

[Code Execution Processing]

Next, processing of executing the execution code ec based on the acquired association information 2300 by use of the code execution unit 1416, which is illustrated in Step S2707 in the flow chart in FIG. 13, will be described below.

FIG. 20 is a flow chart illustrating processing of executing the execution code ec by the code execution unit 1416. The code execution unit 1416 sequentially instructions in the execution code ec according to the detected internal state 1600 and the association information 2300 (Step S2101). The code execution unit 1416 determines whether or not the external dependence instruction included in the target block is executed (Step S2102).

When it is determined that the external dependence instruction included in the target block is not executed (Step S2102: No), the code execution unit 1416 proceeds to Step S2104.

When it is determined that the external dependence instruction included in the target block is executed (Step S2102: Yes), the code execution unit 1416 causes the correction unit 1417 to execute correction processing according to the external dependence instruction (Step S2103). Details of the processing in Step S2103 will be described below using a flow chart in FIG. 22. Then, the code execution unit 1416 outputs an execution result as the simulation information 1430 (Step S2104).

Next, the code execution unit 1416 determines whether or not execution of the instructions included in the target block is finished (Step S2105). When it is determined that execution is finished (Step S2105: Yes), the code execution unit 1416 finishes the series of processing. On the contrary, when it is determined that execution is not finished (Step S2105: No), the code execution unit 1416 returns to Step S2101.

[Correction Processing]

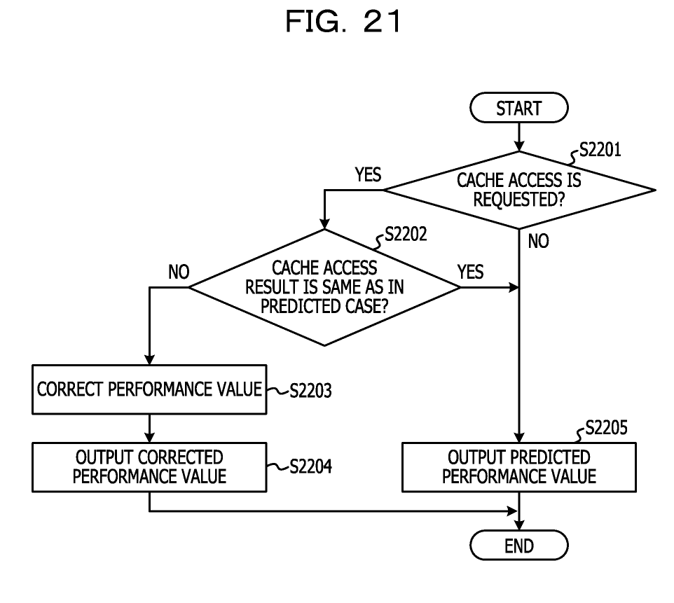

FIG. 21 is a flow chart illustrating calling processing of the correction unit 1417 in Step S2103 in FIG. 20 in detail.

First, the correction unit 1417 determines whether or not cache access is requested (Step S2201). When the cache access is not requested (Step S2201: No), the correction unit 1417 proceeds to Step S2205. When the cache access is requested (Step S2201: Yes), simulation in Step S2203 is the operational simulation sim. The correction unit 1417 determines whether or not the result of the cache access is the same as the predicted case (Step S2202).

When the result of the cache access is not the same as the predicted case (Step S2202: No), the correction unit 1417 corrects the performance value (Step S2203). Then, the correction unit 1417 outputs the corrected performance value (Step S2204), and finishes the series of processing. When it is determined that the result of the cache access is the same as the predicted case (Step S2202: Yes), the correction unit 14170 outputs the predicted performance value included in the association information 101 (Step S2205), and finishes the series of processing.

As described above, the simulation method in this embodiment includes a generation step of sequentially generating the association information 2300 that associates the internal state 1600 detected when the target block changes with the performance value 2200 of each instruction of the target block, and the execution code ec, and storing them in the memory. The internal state 1600 represents the internal state of the target processor 1200. The target block represents the program targeted for simulation, which is divided from the program of the target processor. The execution code represents the execution program of the processor that converts the target block.

The simulation method includes a calculation step of executing the execution code based on the association information corresponding to the internal state, and calculating the performance value of the target block. The simulation method includes a deletion step of deleting the block execution code and the association information that are selected from a plurality of blocks based on the probability of execution in response to a branch in the preceding block.

This can delete block information 3100 of the block being less likely to be executed from the memory. That is, it is possible to keep the block information 3100 of the block being likely to be executed from being deleted from the memory 213. Thus, simulation apparatus 100 can suppress recompile processing of the block to be executed and processing of generating the association information 2300.

The simulation apparatus 100 can perform highly accurate performance simulation abased on the association information 2300 while minimizing recompile processing and processing of generating the association information 2300. That is, the simulation apparatus 100 can keep the speed of performance simulation while improving the accuracy of performance simulation.

The generation step of the simulation method in this embodiment includes a step of generating the target block execution code ec when the target block execution code ec is not stored in the memory, and storing the target block execution code ec in the memory. The generation step includes a step of reading the execution code when the execution code is stored.

Thus, the simulation apparatus 100 can delete the block execution code ec and the association information 2300 that are selected according to the probability of execution in response to a branch in the preceding block, and store the new execution code ec in the memory. This can reduce the frequency of compile processing.

The generation step of the simulation method in this embodiment includes a step of generating the association information 2300 that associates the internal state 1600 with the performance value 2200 when the association information 2300 including the matched internal state 1600 is not stored in the memory, and storing the generate association information 2300 in the memory. The generation step includes a step of reading the association information when the association information is stored.

Accordingly, the simulation apparatus 100 can delete the block execution code ec and the association information 2300 that are selected based on the probability of execution in response to a branch in the preceding block, and store new association information 2300 in the memory. This can reduce the frequency of processing of generating the association information 2300.

In the deletion step of simulation method in this embodiment, the block having the lowest probability of execution in response to a branch in the preceding block is selected from among a plurality of blocks. Thus, the simulation apparatus 100 can properly select the block being less likely to be executed and delete the block information 3100 of the selected block. The simulation apparatus 100 keeps the block that has not been executed for a certain time, but is likely to be executed from being selected as the block with block information 3100 to be deleted.

In the deletion step of the simulation method in this embodiment, the block that has not been executed for a predetermined time is detected is detected, and the block having a low probability of execution in response to a branch in the detected block is selected from among blocks executed following the detected block.

Thus, the simulation apparatus 100 can properly detect the block that has not been executed for a long time and is less likely to be executed, and delete the execution code ec and the association information 2300. Thus, the simulation apparatus 100 can store the block information 3100 of the block being likely to be reexecuted in the block information storage region 213 more reliably.

In the deletion step of the simulation method in this embodiment, the branch code having the highest possibility of a branch or no branch is detected based on a value of the saturating counter for each branch code of the program. The value of the saturating counter is generated by the target processor. In the deletion step, when the value of the saturating counter indicates the possibility that the detected branch code branches, the block executed next when the branch code does not branch is selected, and when the value of the saturating counter indicates the possibility that the detected branch code does not branch, the block executed next when the branch code branches is selected.

Thus, the simulation apparatus 100 can efficiently detect the block being less likely to be executed based on the counter value of the counter table 2800 generated according to the algorithm of the saturating counter. The simulation apparatus 100 can keep the block that has not been executed for a long time, but is likely to be executed from being selected as the block with the block information 3100 to be deleted. As a result, the simulation apparatus 100 can store the block information 3100 of the block being likely to be reexecuted in the memory 213 more reliably.

The simulation apparatus 100 uses the counter table 2800 generated by using the branch predicting function that is an existing function of the processor. Thereby, the simulation apparatus 100 can detect the block being less likely to be executed more efficiently. Since the branch predicting function is a model previously equipped in the simulator, generation of the counter table 2800 does not exert any additional load on the simulation processing.

In the deletion step of the simulation method in this embodiment, when free space on the memory is smaller than the reference value, the selected block execution code ec and the association information 2300 are deleted. Thus, when free space on the memory 213 is smaller than the reference value, the simulation apparatus 100 delete the selected block execution code ec and the association information 2300 corresponding to the block. Therefore, before lacking in free space on the memory, the simulation apparatus 100 can ensure free space on the memory that stores the execution code ec and the association information 2300.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A simulation method to be executed by a computer including a processor configured to execute processing and a memory configured to store an execution result of the processor, the method comprising:
each time a target block to be simulated among a plurality of blocks produced by dividing a program of a target processor to be simulated changes from one to another among the plurality of blocks, generating association information that associates an internal state of the target processor with a performance value of each instruction of the target block, and an execution code of the target processor to which program included in the target block is converted;
storing the generated association information and execution code in the memory;
executing the execution code using the association information associated with the internal state to calculate the performance value of the target block;
selecting a block to be deleted from among the plurality of blocks produced by dividing the program of the target processor based on a probability of execution in response to a branch in a preceding block in execution; and
deleting the execution code and the association information of the selected block from the memory.

2. The method according to claim 1, wherein
the generating generates the execution code of the target block when the execution code of the target block is not stored in the memory.

3. The method according to claim 2, wherein
when the execution code of the target block is stored in the memory, the generating does not generate the execution code of the target block, the storing does not store the execution code in the memory, and the executing reads out the stored execution code from the memory and executes the read out execution code.

4. The method according to claim 1, wherein
the generating generates the association information when the association information corresponding to the internal state is not stored in the memory.

5. The method according to claim 4, wherein
when the association information corresponding to the internal state is stored in the memory, the generating does not generate the association information, the storing does not store the association information in the memory, and the executing reads out the stored association information from the memory.

6. The method according to claim 1, wherein
the selecting selects a block having a lowest probability of execution in response to a branch in a preceding block from the plurality of blocks.

7. The method according to claim 6, further comprising:
detecting one or more blocks not executed for a predetermined time from the plurality of blocks,
wherein the selecting selects a block having a low probability of execution in response to a branch in any of the detected one or more blocks among from blocks to be executed next to the detected one or more blocks.

8. The method according to claim 6, further comprising:
detecting a branch code having a highest possibility of a branch or no branch indicated by the value of the saturating counter based of a value of a saturating counter for each branch code of the program of the target processor,
wherein, when the value of the saturating counter of the detected branch code indicates the possibility of a branch, the selecting selects a block to be executed next when the branch code does not branch is selected.

9. The method according to claim 8, wherein
when the value of the saturating counter of the detected branch code indicates the possibility of no branch, the selecting selects a block to be executed next when the branch code branches.

10. The method according to claim 1, wherein
the deleting deletes the execution code and the association information of the selected block when free space on the memory is smaller than a reference value.

11. A non-transitory computer-readable medium storing therein a simulation program that causes a computer to execute a simulation process of a simulation target processor, the process comprising:
each time a target block to be simulated among a plurality of blocks produced by dividing a program of a target processor to be simulated changes from one to another among the plurality of blocks, generating association information that associates an internal state of the target processor with a performance value of each instruction of the target block, and an execution code of the target processor to which program included in the target block is converted;
storing the generated association information and execution code in the memory;
executing the execution code using the association information associated with the internal state to calculate the performance value of the target block;
selecting a block to be deleted from among the plurality of blocks produced by dividing the program of the target processor based on a probability of execution in response to a branch in a preceding block in execution; and
deleting the execution code and the association information of the selected block from the memory.

12. The non-transitory computer-readable medium according to claim 11, wherein
the generating generates the execution code of the target block when the execution code of the target block is not stored in the memory.

13. The non-transitory computer-readable medium according to claim 11, wherein
when the execution code of the target block is stored in the memory, the generating does not generate the execution code of the target block, the storing does not store the execution code in the memory, and the executing reads out the stored execution code from the memory and executes the read out execution code.

14. The non-transitory computer-readable medium according to claim 11, wherein
the generating generates the association information when the association information corresponding to the internal state is not stored in the memory.

15. The non-transitory computer-readable medium according to claim 14, wherein
when the association information corresponding to the internal state is stored in the memory, the generating does not generate the association information, the storing does not store the association information in the memory, and the executing reads out the stored association information from the memory.

16. The non-transitory computer-readable medium according to claim 11, wherein
the selecting selects a block having a lowest probability of execution in response to a branch in a preceding block from the plurality of blocks.

17. The non-transitory computer-readable medium according to claim 16, further comprising:
detecting one or more blocks not executed for a predetermined time from the plurality of blocks,
wherein the selecting selects a block having a low probability of execution in response to a branch in any of the detected one or more blocks among from blocks to be executed next to the detected one or more blocks.

18. The non-transitory computer-readable medium according to claim 16, further comprising:
detecting a branch code having a highest possibility of a branch or no branch indicated by the value of the saturating counter based of a value of a saturating counter for each branch code of the program of the target processor,
wherein, when the value of the saturating counter of the detected branch code indicates the possibility of a branch, the selecting selects a block to be executed next when the branch code does not branch is selected.

19. The non-transitory computer-readable medium according to claim 18, wherein
when the value of the saturating counter of the detected branch code indicates the possibility of no branch, the selecting selects a block to be executed next when the branch code branches.

20. The non-transitory computer-readable medium according to claim 11, wherein
the deleting deletes the execution code and the association information of the selected block when free space on the memory is smaller than a reference value.
